(19) United States
(12) Patent Application Publication
(10) Pub. No.: US 2015/0357698 A1
(43) Pub. Date: Dec. 10, 2015

(54) WIDEBAND TRANSITION BETWEEN A PLANAR TRANSMISSION LINE AND A WAVEGUIDE

(71) Applicants: Taras KUSHTA, Minato-ku, Tokyo (JP); NEC CORPORATION, Minato-ku Tokyo (JP)

(72) Inventor: Taras KUSHTA, Tokyo (JP)

(73) Assignee: NEC CORPORATION, Minato-ku Tokyo (JP)

(21) Appl. No.: 14/759,971

(22) PCT Filed: Jan. 10, 2013
(86) PCT No.: PCT/JP2013/000068

§ 371 Date: Jul. 9, 2015

(51) Int. Cl. H01P 5/08; H01P 3/08

(52) U.S. Cl. CPC H01P 5/08; H01P 3/088; H01P 3/082

(57) ABSTRACT

A wideband transition between a planar transmission line and a waveguide of this invention comprises a substrate, a segment of the planar transmission line and a section of the waveguide. The substrate includes a plurality of conductor-layers stacked from top to bottom and isolated by an insulating material. The segment of the planar transmission line is disposed in a top conductor-layer of the plurality of conductor-layers. The section of the waveguide is disposed on a bottom conductor-layer of the plurality of conductor-layers by a first end. The substrate comprises a conductive patch and a conductive dispersion plate. The conductive patch is disposed in the top conductor-layer and connected to a first end of said segment. The conductive dispersion plate is disposed in the bottom conductor-layer and under the conductive patch. The conductive dispersion plate comprises a corrugation.

### TECHNICAL FIELD

The present invention relates to a wideband transition between a microwave circuit and an antenna.

### BACKGROUND ART

It is a crucial problem providing transmittance of an electromagnetic wave between a microwave circuit element and an antenna with low return and insertion losses in a microwave (millimeter-wave) module in different practical applications, including automotive radar systems. An appropriate transition structure can improve energy consumption in the systems.

In inventions U.S. Pat. No. 5,867,073, U.S. Pat. No. 6,127,901, US 2008/0129408 and US 2012/0050125, different structures of the transition between a planar transmission line and a waveguide are proposed.

However, development of the transition operating in a wide frequency band is vital for providing a low-cost microwave (millimeter-wave) module overcoming fabrication process tolerance problems.

### CITATION LIST

### Patent Literature

[PTL 1] U.S. Pat. No. 5,867,073

[PLT 2] U.S. Pat. No. 6,127,901

[PLT 3] US Laid Open Patent Publication 2008/0129408

[PLT 4] US Laid Open Patent Publication 2012/0050125

### SUMMARY OF INVENTION

It is an object of the present invention to form a wideband transition between a waveguide and a planar transmission line disposed in a multilayer substrate.

Here, such wideband transition is obtained by forming an aperture under a conductive patch connected to the planar transmission line and a specific dispersion plate disposed within the aperture under the conductive patch. A distinguishing point of this specific dispersion plate is corrugation of an edge which provides a wideband operation of the wideband transition.

### BRIEF DESCRIPTION OF DRAWINGS

FIG. 1A is a top view of a wideband transition between a planar transmission line and a waveguide of an exemplary embodiment of the present invention.

FIG. 1B is a vertical cross-sectional view of the wideband transition shown in FIG. 1A on 1B-1B section.

FIG. 1C is a vertical cross-sectional view of the wideband transition shown in FIG. 1A on 1C-1C section.

FIG. 1D is a horizontal cross-sectional view of the wideband transition shown in FIG. 1A on the section at conductor-layers 1L2, 1L3 and 1L4.

FIG. 1E is a horizontal cross-sectional view of the wideband transition shown in FIG. 1A on the section at conductor-layer 1L5.

FIG. 1F is a bottom view of the wideband transition shown in FIG. 1A.

FIG. 1G is a horizontal cross-sectional view of the wideband transition shown in FIG. 1A on the section conductor-layer 1L5 showing notations used in marking characteristic details of the corrugated plate.

FIG. 2 is a graph showing the effect of the corrugation for a dispersion plate on return losses of the transition.

FIG. 3 is a graph showing the effect of the corrugation for a dispersion plate on insertion losses of the transition.

FIG. 4 is a graph showing the effect of the corrugation for a dispersion plate on energy balance in the transition.

FIG. 5A is a top view of a wideband transition between a planar transmission line and a waveguide of another exemplary embodiment of the present invention.

FIG. 5B is a vertical cross-sectional view of the wideband transition shown in FIG. 5A on 2B-2B section.

FIG. 5C is a vertical cross-sectional view of the wideband transition shown in FIG. 5A on 2C-2C section.

FIG. 5D is a horizontal cross-sectional view of the wideband transition shown in FIG. 5A on the section at conductor-layers 2L2 and 2L3.

FIG. 5E is a bottom view of the wideband transition shown in FIG. 5A.

FIG. 6A is a top view of a wideband transition between a planar transmission line and a waveguide of further another exemplary embodiment of the present invention.

FIG. 6B is a vertical cross-sectional view of the wideband transition shown in FIG. 6A on 3B-3B section.

FIG. 6C is a vertical cross-sectional view of the wideband transition shown in FIG. 6A on 3C-3C section.

FIG. 6D is a horizontal cross-sectional view of the wideband transition shown in FIG. 6A on the sections at conductor-layers 3L2 and 3L4.

FIG. 6E is a horizontal cross-sectional view of the wideband transition shown in FIG. 6A on the section at conductor-layer 3L3.

FIG. 6F is a horizontal cross-sectional view of the wideband transition shown in FIG. 6A on the section at conductor-layer 3L5.

FIG. 6G is a bottom view of the wideband transition shown in FIG. 6A.

FIG. 7A is a top view of a wideband transition between a planar transmission line and a waveguide of a further another exemplary embodiment of the present invention.

FIG. 7B is a vertical cross-sectional view of the wideband transition shown in FIG. 7A on 4B-4B section.

FIG. 7C is a vertical cross-sectional view of the wideband transition shown in FIG. 7A on 4C-4C section.

FIG. 7D is a horizontal cross-sectional view of the wideband transition shown in FIG. 7A on the sections at conductor-layers 4L2, 4L3, and 4L4.

FIG. 7E is a horizontal cross-sectional view of the wideband transition shown in FIG. 7A on the section at conductor-layer 4L5.

FIG. 7F is a bottom view of the wideband transition shown in FIG. 7A.

FIG. 8A is a top view of a wideband transition between a planar transmission line and a waveguide of a further another exemplary embodiment of the present invention.

FIG. 8B is a vertical cross-sectional view of the wideband transition shown in FIG. 8A on 5B-5B section.

FIG. 8C is a vertical cross-sectional view of the wideband transition shown in FIG. 8A on 5C-5C section.

FIG. 8D is a horizontal cross-sectional view of the wideband transition shown in FIG. 8A on the sections at conductor-layers 5L2, 5L3, and 5L4.

FIG. 8E is a horizontal cross-sectional view of the wideband transition shown in FIG. 8A on the section at conductor-layer 5L5.

FIG. 8F is a bottom view of the wideband transition shown in FIG. 8A.

FIG. 9A is a top view of a wideband transition between a planar transmission line and a waveguide of a further another exemplary embodiment of the present invention.

FIG. 9B is a vertical cross-sectional view of the wideband transition shown in FIG. 9A on 6B-6B section.

FIG. 9C is a vertical cross-sectional view of the wideband transition shown in FIG. 9A on 6C-6C section.

FIG. 9D is a horizontal cross-sectional view of the wideband transition shown in FIG. 9A on the sections at conductor-layers 6L2 and 6L4.

FIG. 9E is a horizontal cross-sectional view of the wideband transition shown in FIG. 9A on the section at conductor-layer 6L3.

FIG. 9F is a horizontal cross-sectional view of the wideband transition shown in FIG. 9A on the section at conductor-layer 6L5.

FIG. 9G is a bottom view of the wideband transition shown in FIG. 9A.

FIG. 10A is a top view of a wideband transition between a planar transmission line and a waveguide of a further another exemplary embodiment of the present invention.

FIG. 10B is a vertical cross-sectional view of the wideband transition shown in FIG. 10A on 7B-7B section.

FIG. 10C is a vertical cross-sectional view of the wideband transition shown in FIG. 10A on 7C-7C section.

FIG. 10D is a horizontal cross-sectional view of the wideband transition shown in FIG. 10A on the sections at conductor-layers 7L2 and 7L4.

FIG. 10E is a horizontal cross-sectional view of the wideband transition shown in FIG. 10A on the section at conductor-layer 7L3.

FIG. 10F is a horizontal cross-sectional view of the wideband transition shown in FIG. 10A on the section at conductor-layer 7L5.

FIG. 10G is a bottom view of the wideband transition shown in FIG. 10A.

### DESCRIPTION OF EXEMPLARY EMBODIMENTS

Hereinafter, several types of wideband transitions disposed in multilayer substrates between a planar transmission line and a waveguide according to the present invention will be described in details with reference to attached drawings. But, it would be well understood that this description should not be viewed as narrowing the appended claims.

### An Exemplary Embodiment

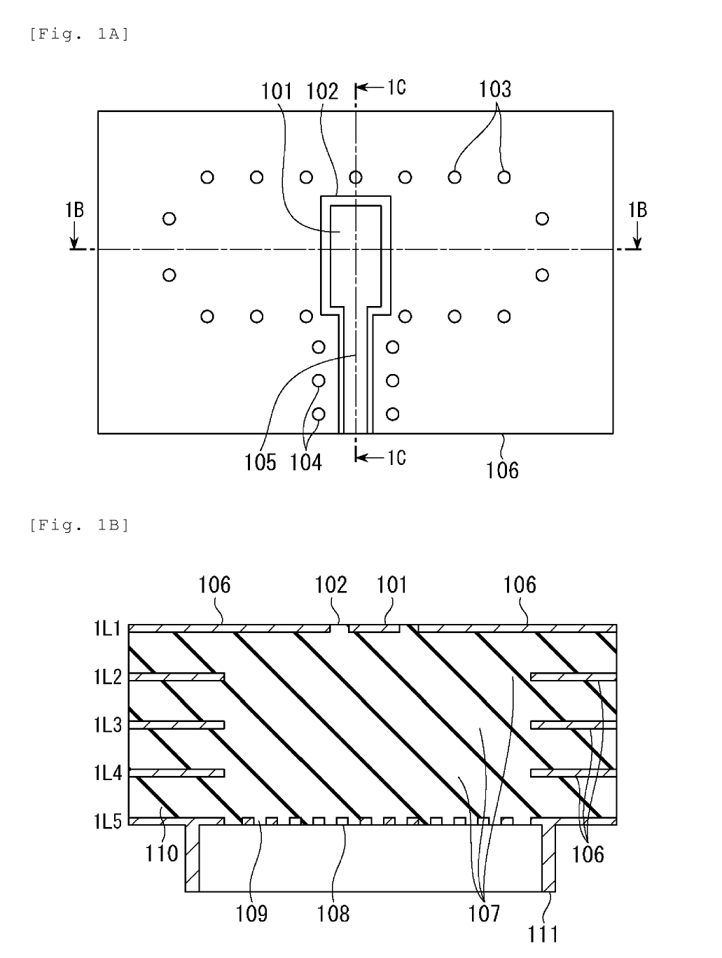

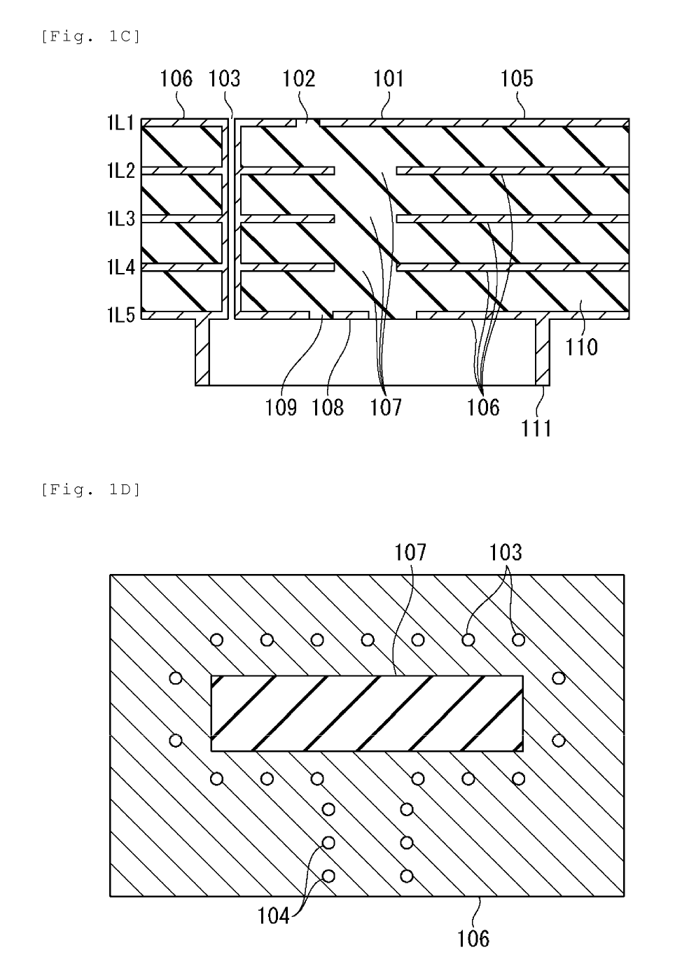

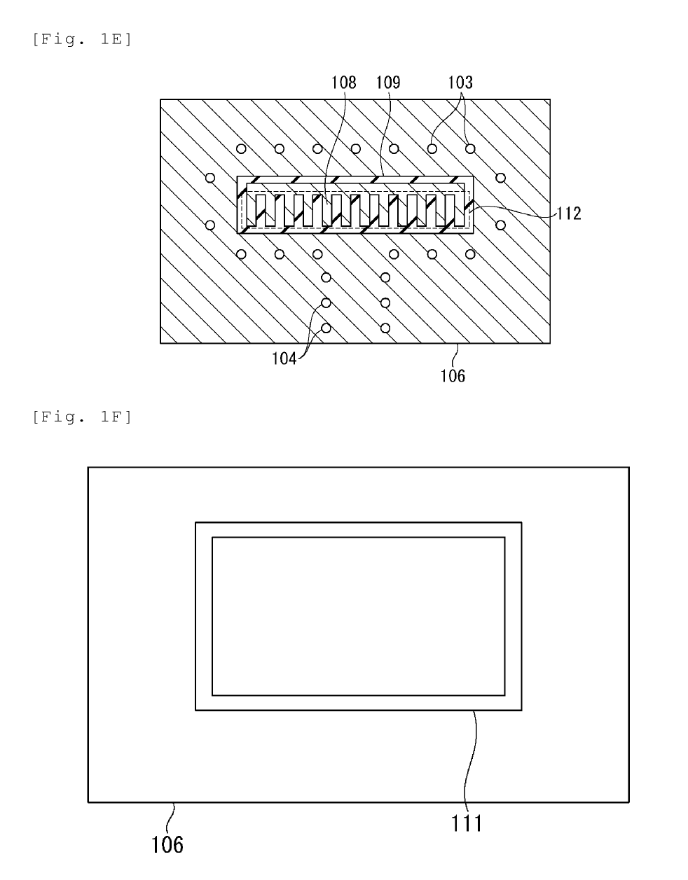

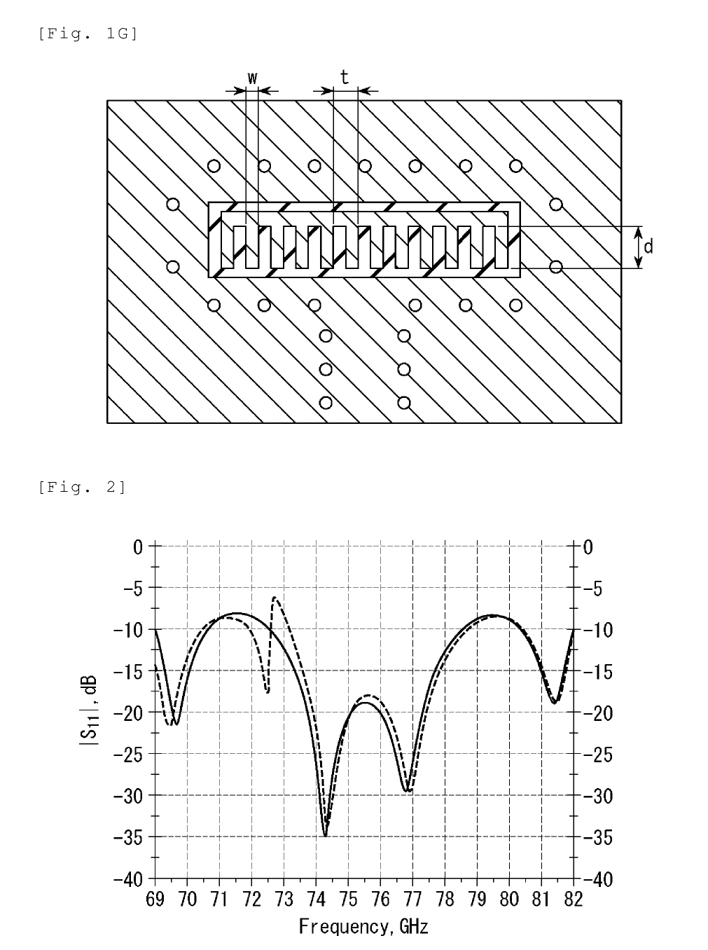

FIG. 1A is a top view of a wideband transition between a planar transmission line and a waveguide of an exemplary embodiment of the present invention. FIG. 1A shows a conductive patch 101, an isolating slit 102, a plurality of ground vias 103 of the wideband transition, a segment of a planar transmission line 105 and a plurality of ground vias 104 of the planar transmission line 105. FIG. 1A also shows two section lines 1B-1B and 1C-1C.

FIG. 1B is a vertical cross-sectional view of the wideband transition shown in FIG. 1A on 1B-1B section. FIG. 1B shows the conductive patch 101, the isolating slit 102, a plurality of layer-conductors 106, a plurality of coupling apertures 107, a conductive dispersion plate 108, a separation slit 109, a substrate material 110 and a section of a waveguide 111. FIG. 1B also shows five conductor-layers 1L1, 1L2, 1L3, 1L4 and 1L5.

FIG. 1C is a vertical cross-sectional view of the wideband transition shown in FIG. 1A on 1C-1C section. FIG. 1C shows the conductive patch 101, the isolating slit 102, one of the plurality of ground vias 103 of the wideband transition, the segment of the planar transmission line 105, the plurality of layer-conductors 106, the plurality of coupling apertures 107, the conductive dispersion plate 108, the separation slit 109, the substrate material 110 and the section of the waveguide 111. FIG. 1C also shows five conductor-layers 1L1, 1L2, 1L3, 1L4 and 1L5.

FIG. 1D is a horizontal cross-sectional view of the wideband transition shown in FIG. 1A on the section at conductor-layers 1L2, 1L3 and 1L4. FIG. 1D shows one of the plurality of layer-conductors 106, one of the plurality of the coupling apertures 107, the plurality of ground vias 103 of the wideband transition and the plurality of ground vias 104 of the planar transmission line 105.

FIG. 1E is a horizontal cross-sectional view of the wideband transition shown in FIG. 1A on the section at conductor-layer 1L5. FIG. 1E shows one of the plurality of layer-conductors 106, the conductive dispersion plate 108 with a corrugation 112, the separation slit 109, the plurality of ground vias 103 of the wideband transition and the plurality of ground vias 104 of the planar transmission line 105.

FIG. 1F is a bottom view of the wideband transition shown in FIG. 1A. FIG. 1F shows the bottom-one of the plurality of layer-conductors 106 and the section of the waveguide 111.

FIG. 1G is a horizontal cross-sectional view of the wideband transition shown in FIG. 1A on the section of the conductor-layer 1L5 showing notations used in marking characteristic details of the corrugated plate. FIG. 1G shows different dimensions of the conductive dispersion plate 108, that is, a corrugation pitch t, a ridge width w and a groove depth d.

In the exemplary embodiment shown in FIGS. 1A to 1G, the wideband transition between a planar transmission line 105 and a waveguide 111 includes the conductive patch 101, the isolating slit 102, the plurality of ground vias 103 of the wideband transition, the plurality of ground vias 104 of the planar transmission line 105, the segment of the planar transmission line 105, the plurality of the layer-conductors 106, the plurality of the coupling apertures 107, the conductive dispersion plate 108 with the corrugation 112, the separation slit 109, the substrate material 110 and the section of the waveguide 111.

In this exemplary embodiment, the wideband transition is formed in a substrate including the plurality of layer-conductors 106 stacked in the plurality of conductor-layers 1L1 to 1L5 and the substrate material 110 filled between the plurality of layer-conductors 106. In other words, in the substrate forming the wideband transition, each of the plurality of layer-conductors 106 is isolates by the substrate material 110. The substrate material 110 is an insulating material, preferably a dielectric material.

In this exemplary embodiment, the number of the plurality of layer-conductors 106 is five, the number of the plurality of the coupling apertures 107 is three and each of the plurality of layer-conductor 106 has a shape of a rectangular envelope, only for an example. Those numbers, the filling dielectric material as the substrate material 110 and other substrate parameters can be different and are defined according to an application.

The layer-conductor 106 in the first conductor-layer 1L1, shown in FIG. 1A, is disposed on the top surface of the substrate and called the first or top layer-conductor 106. The first conductor-layer 1L1 also includes the conductive patch 101, the isolating slit 102 and the segment of the planar transmission line 105. One end of the segment of the transmission line 105 is connected to the conductive patch 101. The isolating slit 102 is disposed around a set of the conductive patch 101 and the segment of the transmission line 105 to isolate them from the first layer-conductor 106.

The layer-conductor 106 in the second conductor-layer 1L2, shown in FIG. 1D, is called the second of intermediate layer-conductors 106. The second layer-conductor 106 has a rectangular-shaped hole, called the coupling aperture 107, filled by the substrate material 110.

Two layer-conductors 106 in the third and the fourth conductor-layers 1L3 and 1L4 have the same shape as the second layer-conductor 106, as shown in FIG. 1D, and are called the third and the fourth layer-conductors 106, respectively, or intermediate layer-conductors 106.

The layer-conductor 106 in the fifth conductor-layer 1L5, shown in FIGS. 1E and 1G, is called the fifth or bottom layer-conductor 106. The fifth conductor-layer 1L5 also includes the conductive dispersion plate 108 and the separation slit 109. The separation slit 109 is disposed around the conductive dispersion plate 108 and isolates it from the fifth layer-conductor 106. In other words, the fifth layer-conductor 106 has a rectangular-shaped hole, called the separation slit 109, filled by the substrate material 110, and the conductive dispersion plate 108 is disposed in this hole.

The conductive dispersion plate 108 has a shape of a rectangular envelope and a comb-like shape. In other words, the conductive dispersion plate 108 includes a corrugation 112 with rectangular ridges and rectangular grooves and aside portion to which each of the rectangular ridges are connected by one end.

The section of the waveguide 111, having a rectangular shape, is connected by one end to the bottom surface of the substrate, that is, the bottom surface of the fifth layer-conductor 106.

Each of the plurality of ground vias 103 of the wideband transition and the plurality of ground vias 104 of the planar transmission line 105 is disposed through the substrate in the direction of stacking the layer-conductors 106. In other words, each of the layer-conductors 106 in the conductor-layers 1L1 to 1L5 and the substrate material 110 are penetrated by the plurality of ground vias 103 of the wideband transition and the plurality of ground vias 104 of the planar transmission line 105.

Each of the plurality of ground vias 103 of the wideband transition and the plurality of ground vias 104 of the planar transmission line 105 has a conductive sidewall connected to every layer-conductor 106 in the conductor-layers 1L1 to 1L5. In other word, any layer-conductor 106 is electrically connected to any other layer-conductor 106 by means of each of the plurality of ground vias 103 of the wideband transition and the plurality of ground vias 104 of the planar transmission line 105.

A first group of the plurality of ground vias 104 of the planar transmission line 105 is arranged along one side of the segment of the planar transmission line 105 and the isolating slit 102. A second group of the plurality of ground vias 104 of the planar transmission line 105 is arranged along the other side of the segment of the transmission line 105 and the isolating slit 102. The plurality of ground vias 103 of the wideband transition is arranged along a periphery of the coupling aperture 107 and the separation slit 109.

In other words, the plurality of ground vias 103 of the wideband transition and the plurality of ground vias 104 of the planar transmission line 105 are surrounding the isolating slit 102, the coupling aperture 107 and the separation slit 109.

The coupling apertures 107 in the second, the third and the fourth conductor-layers 1L2, 1L3 and 1L4 and the separation slit 109 have a same peripheral size and are superimposed one by one. The conductive patch 101 is disposed over the three coupling apertures 107 and the conductive dispersion plate 108. The section of the waveguide 111 is disposed under the conductive dispersion plate 108. The conductive dispersion plate 108 and the separation slit 109 are disposed inward of an opening of the section of the waveguide 111 at the bottom conductor-layer 1L5.

In this embodiment, while one end of the segment of the planar transmission line 105 is connected to the conductive patch 101, the other end of the segment of the planar transmission line segment 105 serves as a first terminal. Also, while one end of the section of the waveguide 111 is connected to the bottom surface of the substrate at the fifth conductor-layer 1L5 under the conductive dispersion plate 108, the other end of the section of the waveguide 111 acts as a second terminal of the wideband transition. The plurality of ground vias 104 of the transmission line 105 are arranged to improve the electrical performance of the planar transmission line 105. Five layer-conductors 106, which are connected to the plurality of ground vias 103 of the wideband transition and the plurality of ground vias 104 of the planar transmission line 105, are used as ground planes of five conductor-layers 1L1 to 1L5, respectively.

A key distinguishing point of this wideband transition is a special corrugation 112, formed with rectangular ridges and grooves, of an edge in the conductive dispersion plate 108 as shown in FIG. 1E. Due to this corrugation 112, a wideband operation of the transition is provided. This property of the wideband transition is attributed to the ridges orientation with respect to the polarization of the electrical field for the wave passing through the conductive dispersion plate 108. For the structure of the conductive dispersion plate 108 shown in FIG. 1E, the electrical field vector is oriented in parallel to corrugation ridges. In this case, the corrugation 112 will provide an inductive effect on the wave. It leads to removing unwanted resonances from an operation range of the transition widening its frequency band.

This electromagnetic behavior can be approximately explained as attributed by a one-dimensional inductive grid (electrical field vector is in parallel to ridges of the dispersion plate), for which the inductance, L_{g,ind}, can be roughly defined as follows:

$${L}_{g , ind} = j \cdot \frac{{Z}_{s}}{2 π f} \cdot ( \frac{t}{λ} ) \cdot ln ( csc ( \frac{π w}{2 t} ) ) \qquad ( 1 )$$

where j is the imaginary number (j²=−1), Zₛ is the characteristic impedance of the substrate material 110, t and w are respectively the ridge pitch and the width of the corrugation 112.

Due to this additional inductance, unwanted resonances will be shifted to the lower frequencies and in-band performance of the wideband transition will be improved. It can be explained in such way. Frequency, fᵣₑₛₒₙₐₙₜ, of an unwanted resonance can be def ined according to following formula:

$${f}_{resonant} = \frac{1}{2 \cdot π \cdot {L}_{resonant} \cdot {C}_{resonant}} \qquad ( 2 )$$

where Lᵣₑₛₒₙₐₙₜ and Cᵣₑₛₒₙₐₙₜ are respectively inductance and capacitance of the structure responsible for the unwanted resonance.

Introduction of an additional inductance to this structure defined according to equation 1 will shift the unwanted resonance to lower frequencies as can be traced from following formula:

$${f}_{resonant} = \frac{1}{2 \cdot π \cdot ( {L}_{resonant} + {L}_{g , ind} ) \cdot {C}_{resonant}} \qquad ( 3 )$$

Due to this effect, the unwanted resonance can be moved to lower frequencies by an appropriate choice of the corrugation from an operation frequency band of the transition providing its wideband operation.

To demonstrate advantages of structures with corrugation in the dispersion plate, simulations of the electrical performance of characteristic transitions were carried out by the Finite-Difference Time-Domain (FDTD) technique, which is one of the most widely-used and accurate numerical methods.

Structure of the wideband transition proposed, which was used in simulations, is similar to that shown in FIGS. 1A to 1F. Characteristic dimensions of this structure were as following: the thickness of the five-conductor-layer substrate was 0.363 mm; the thickness was 0.022 mm in top and bottom layer-conductors 106; the thickness was 0.013 mm in each of the intermediate layer-conductors 106; the width and length of the rectangular conductive patch 101 were 0.28 mm and 0.85 mm, respectively; the width of the isolating slit 102 between the conductive patch 101 and the layer-conductor 106 as a ground plane at the top conductor-layer 1L1 was 0.6 mm; the width and length of the coupling apertures 107 in the intermediate conductor-layers 1L2 to 1L4 and the separating slit 109 in the bottom conductor-layer 1L5 were 0.5 mm and 2.54 mm, respectively; and the width and length of the conductive dispersion plate 108 disposed at the bottom conductor-layer 1L5 were 0.3 mm and 2.34 mm, respectively.

Dimensions of the corrugation 112, as shown in FIG. 1G, were as following: the corrugation pitch t=0.2 mm; the ridge width w=0.1 mm; and the groove depth d=0.18 mm.

In simulations, five layer-conductors 106 were made of copper and isolated by a substrate material 110 with a relative permittivity of 3.5, a dielectric loss of 0.06, a relative permeability of 1 and a magnetic loss of 0.

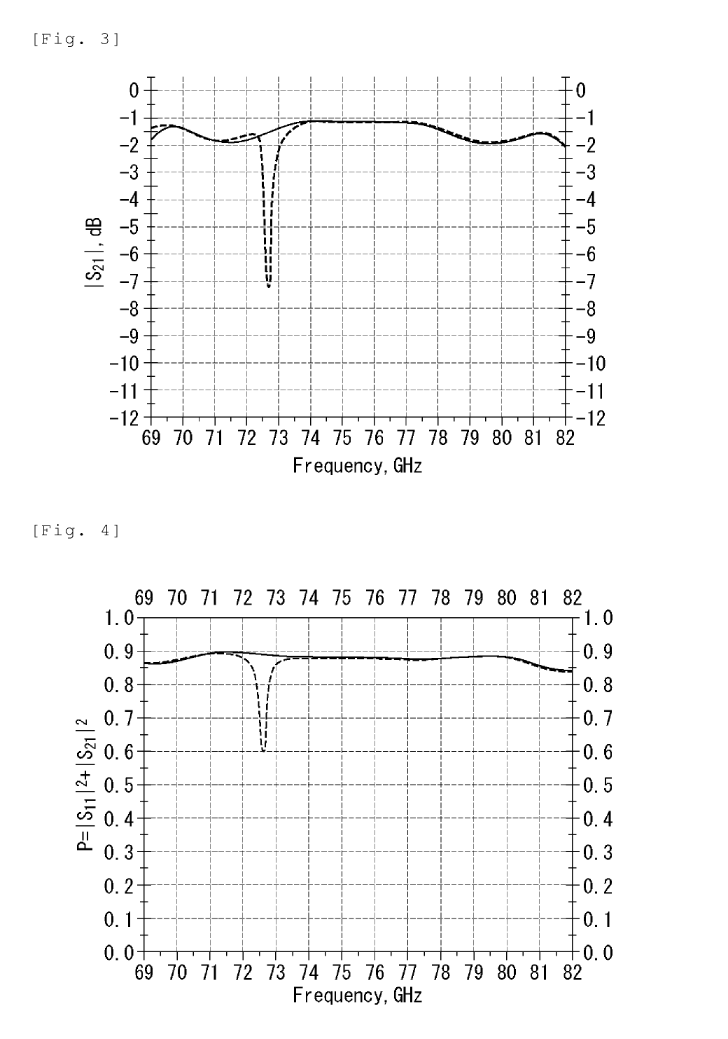

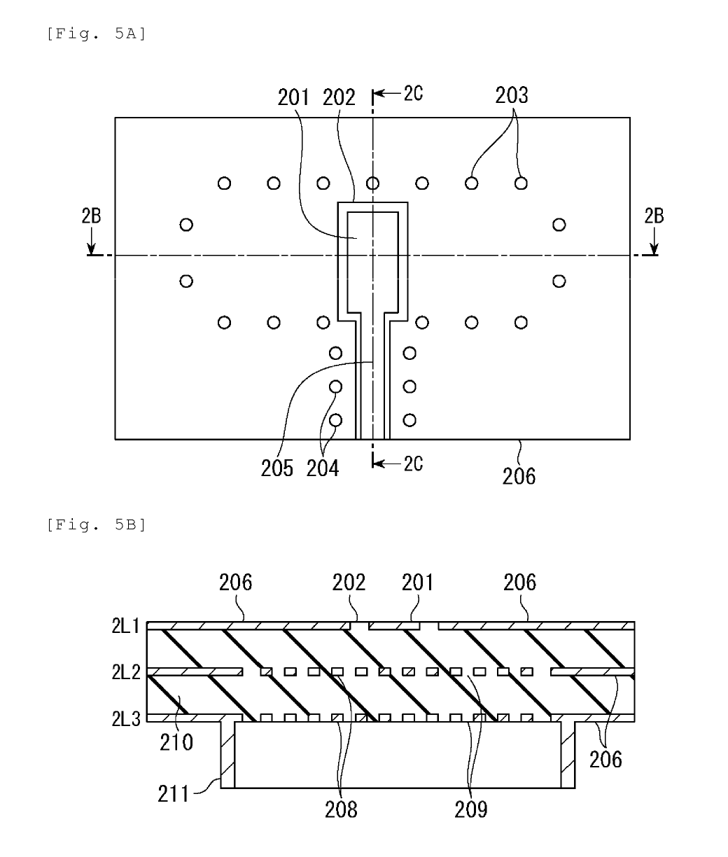

FIG. 2 is a graph showing the effect of the corrugation for a dispersion plate on return losses of the transition. FIG. 3 is a graph showing the effect of the corrugation for the dispersion plate on insertion losses of the transition. FIG. 4 is a graph showing the effect of the corrugation for the dispersion plate on energy balance in the transition.

In FIGS. 2 and 3, return loss (|S₁₁|-parameter) and insertion loss (|S₂₁|-parameter) of the above-simulated wideband transition are respectively presented. Moreover in FIG. 4, energy balance P, defined as P=|S₁₁|²+|S₂₁|², is shown.

In each of FIGS. 2, 3 and 4, a first graph drawn with a solid line shows a case in which the conductive dispersion plate 108 with the corrugation 112 as shown in FIG. 1E is provided and a second graph drawn with a broken line shows a case in which a smooth dispersion plate without corrugation, with a rectangular-shape and peripheral sizes same as the conductive dispersion plate 108, is provided instead of the conductive dispersion plate 108 with corrugation 112.

As one can see in FIGS. 2 to 4, an unwanted resonance at the frequency about 72.7 GHz within an operation band ranged from 69 GHz to 82 GHz is occurred in the case of the transition with smooth dispersion plate. However, the use of the corrugation 112 in the conductive dispersion plate 108 removed this unwanted resonance from the operation band.

Thus, corrugation 112 in a conductive dispersion plate 108 of a transition used between a waveguide and a planar transmission line leads to not only improvement of the transmission characteristics (see FIGS. 2 and 3), but also to reduction of the stray radiation from the transition as follows from FIG. 4.

### Another Exemplary Embodiment

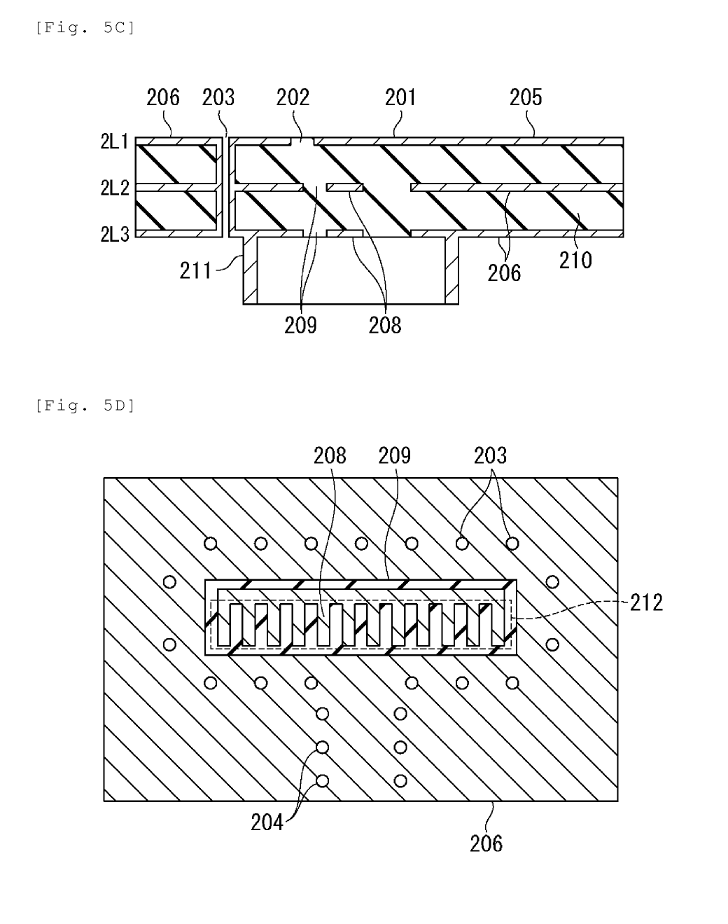

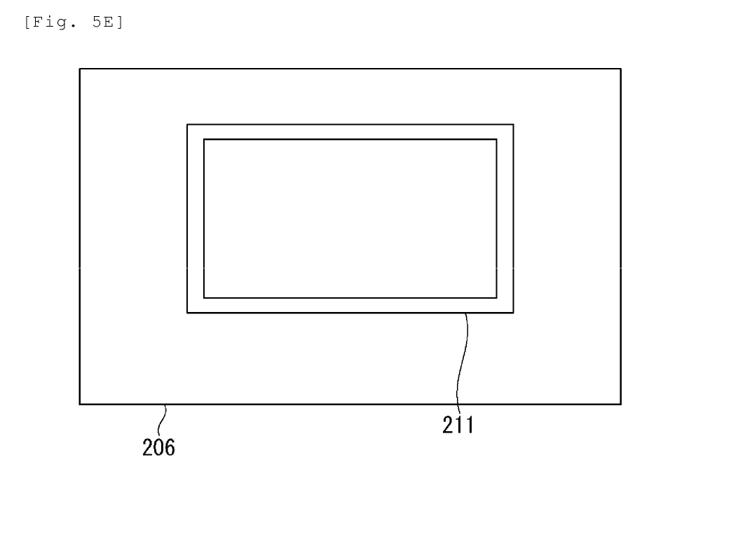

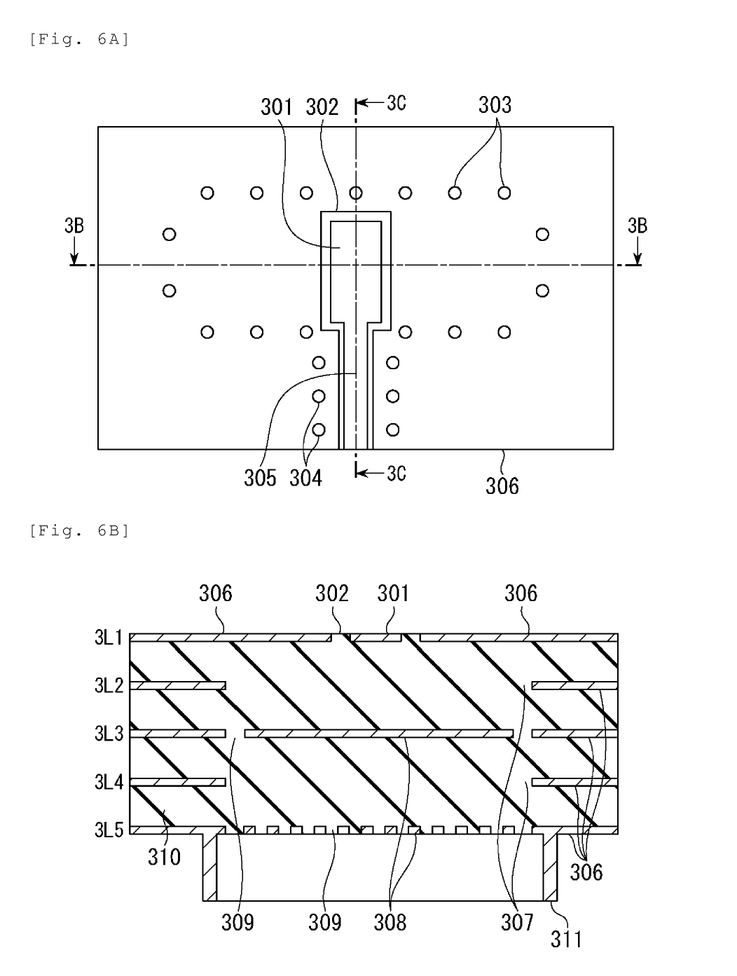

FIG. 5A is a top view of a wideband transition between a planar transmission line and a waveguide of another exemplary embodiment of the present invention. FIG. 5A shows a conductive patch 201, an isolating slit 202, a plurality of ground vias 203 of the wideband transition, a plurality of ground vias 204 of a planar transmission line 205, a segment of the planar transmission line 205, a top layer-conductor 206 and two section lines 2B-2B and 2C-2C.

FIG. 5B is a vertical cross-sectional view of the wideband transit ion shown in FIG. 5A on 2B-2B section. FIG. 5B shows a top conductor-layer 2L1, an intermediate conductor-layer 2L2, a bottom conductor-layer 2L3, the conductive patch 201, the isolating slit 202, a plurality of layer-conductors 206, two conductive dispersion plates 208, two separation slits 209, a substrate material 210 and a section of a waveguide 211.

FIG. 5C is a vertical cross-sectional view of the wideband transit ion shown in FIG. 5A on 2B-2B section. FIG. 5C shows the top conductor-layer 2L1, the intermediate conductor-layer 2L2, the bottom conductor-layer 2L3, the conductive patch 201, the isolating slit 202, one of the plurality of ground vias 203 of the wideband transition, the segment of the planar transmission line, the plurality of layer-conductors 206, the two conductive dispersion plates 208, the two separation slits 209, the substrate material 210 and the section of the waveguide 211.

FIG. 5D is a horizontal cross-sectional view of the wideband transition shown in FIG. 5A on the section at conductor-layers 2L2 and 2L3. FIG. 5D shows the plurality of ground vias 203 of the wideband transition, the plurality of ground vias 204 of the planar transmission line 205, an intermediate layer-conductor 206, one of the conductive dispersion plates 208, one of the separation slits 209 and a corrugation 212 of the conductive dispersion plate 208.

FIG. 5E is a bottom view of the wideband transition shown in FIG. 5A. FIG. 5E shows the bottom layer-conductor 206 and the section of the waveguide 211.

In FIGS. 5A to 5E, another exemplary embodiment of a wideband transition between a planar transmission line 205 and a waveguide 211 is presented. In the present exemplary embodiment, the wideband transition is formed in a substrate comprising three conductor-layers 2L1, 2L2 and 2L3, which are isolated by a substrate material 210.

Each element shown in FIGS. 5A to 5E corresponds to an element shown in FIGS. 1A to 1G in its functional capability. That is, the plurality of conductor-layers 2L1 to 2L3 corresponds to the plurality of conductor-layers 1L1 to 1L5. The top conductor-layer 2L1 corresponds to the top conductor-layer 1L1. The bottom conductor-layer 2L3 corresponds to the bottom conductor-layer 1L5. The intermediate conductor-layer 2L2 corresponds to one of the intermediate conductor-layers 1L2 to 1L4. The conductive patch 201 corresponds to the conductive patch 101. The isolating slit 202 corresponds to the isolating slit 102. The plurality of ground vias 203 of the wideband transition corresponds to the plurality of ground vias 103 of the wideband transition. The plurality of ground vias 204 of the planar transmission line 205 corresponds to the plurality of ground vias 104 of the planar transmission line 105. The segment of the planar transmission line 205 corresponds to the segment of the planar transmission line 105. The top layer-conductor 206 corresponds to the top layer-conductor 106. The bottom layer-conductor 206 corresponds to the bottom layer-conductor 106. The intermediate layer-conductor 206 corresponds to one of the intermediate layer-conductors 106. The conductive dispersion plate 208 in the bottom conductor-layer 2L3 corresponds to the conductive dispersion plate 108. The separation slit 209 in the bottom conductor-layer 2L3 correspond to the separation slit 109 in the bottom conductor-layer 1L5. The substrate material 210 corresponds to the substrate material 110. The section of the waveguide 211 corresponds to the section of the waveguide 111. The corrugation 212 in the conductive dispersion plate 208 in the bottom conductor-layer 2L3 corresponds to the corrugation 112 in the conductive dispersion plate 108.

While the wideband transition shown in FIGS. 1A to 1G includes one conductive dispersion plate 108 with the corrugation 112 and one separation slit 109 in the bottom conductor-layer 1L5, the wideband transition in the present exemplary embodiment includes two conductive dispersion plates 208 with the corrugation 212 and two separation slits 209 in the bottom conductor-layer 2L3 and the intermediate conductor-layer 2L2. In other words, the intermediate conductor-layer 2L2 and the bottom conductor-layer 2L3 both have the same configuration as the bottom conductor-layer 1L5.

In the present exemplary embodiment, the wideband transition is formed by the conductor patch 201 connected to one end of the planar transmission line segment 205, the isolating slit 202 disposed between said conduct or patch 201 and other conductors arranged in the conductor plane 206 of the 2L1 layer, the plurality of ground vias 203 of the wideband transition, dispersion plates 208 disposed in conductor-layers 2L2 and 2L3, and separation slits 209 isolating said dispersion plates 208 from other conductors at the 2L2 and 2L3. In this embodiment, another end of the planar transmission line segment 205 serves as a first terminal. Also, one end of waveguide section 211 is disposed under said dispersion plate 208 and another end of said waveguide 211 acts as a second terminal of the wideband transition. To improve the electrical performance of the segment of the planar transmission line 205, the plurality of ground vias 204 is arranged along the segment of the planar transmission line 205.

Thus, in the present exemplary embodiment, two conductive dispersion plates 208 arranged directly under the conductor patch at two different conductor-layers are used to control the bandwidth of the wideband transition. Both conductive dispersion plates 208 have the corrugation 212 at an edge as shown in FIG. 5D.

### Further Another Exemplary Embodiment

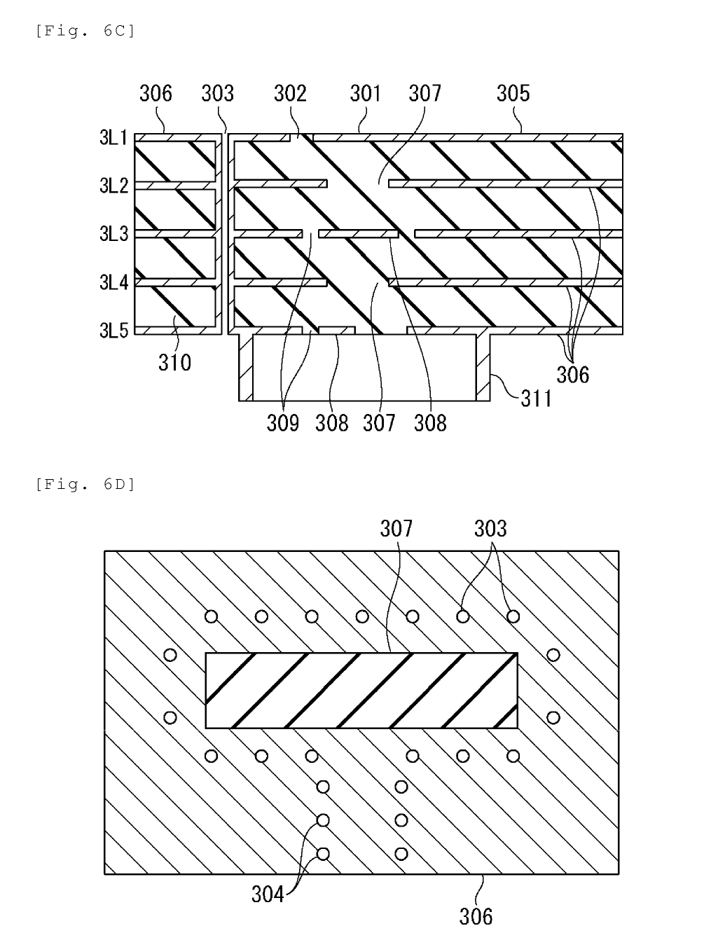

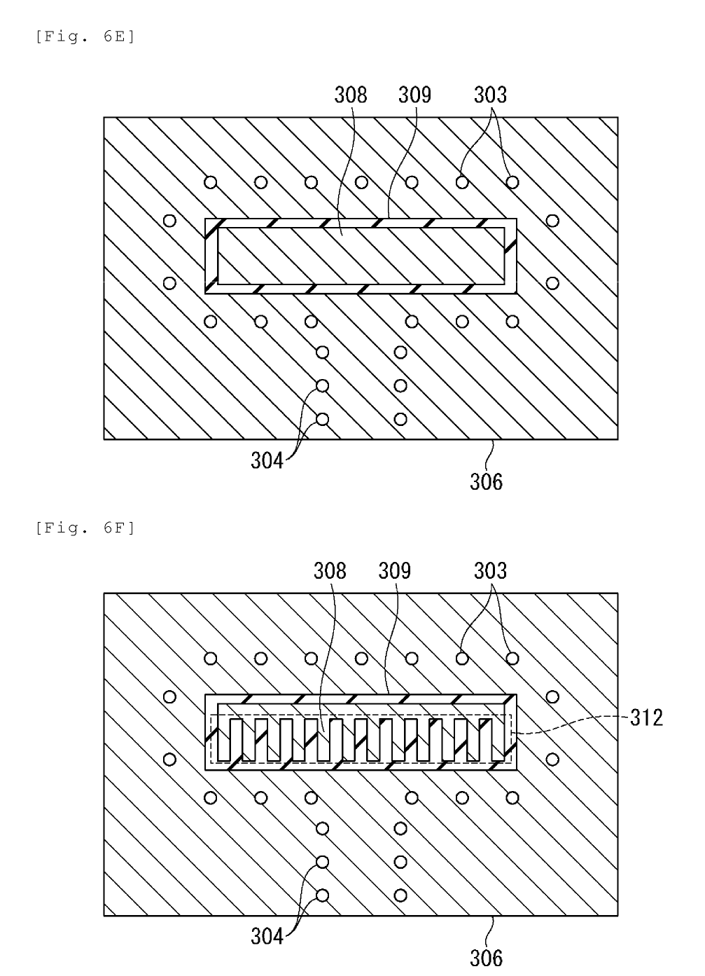

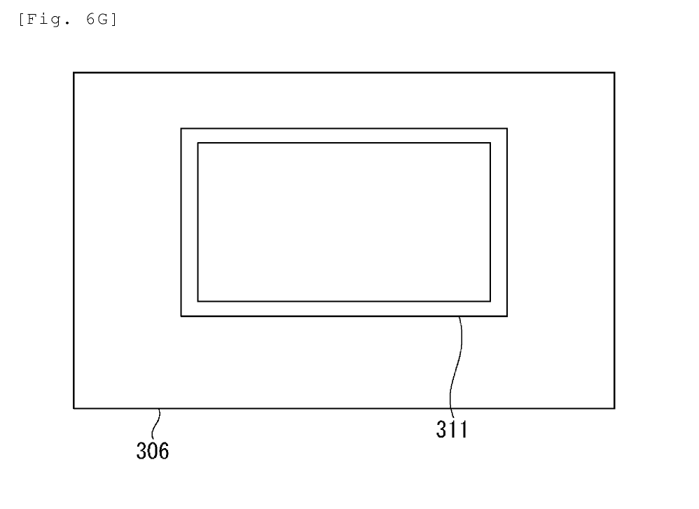

FIG. 6A is a top view of a wideband transition between a planar transmission line and a waveguide of further another exemplary embodiment of the present invention. FIG. 6A shows a conductive patch 301, an isolating slit 302, a plurality of ground vias 303 of the wideband transition, a segment of a planar transmission line 305, a plurality of ground vias 304 of the planar transmission line 305, a top layer-conductor 306 and two section lines 3B-3B and 3C-3C.

FIG. 6B is a vertical cross-sectional view of the wideband transition shown in FIG. 6A on 3B-3B section. FIG. 6B shows a top conductor-layer 3L1, intermediate conductor-layers 3L2 to 3L4, a bottom conductor-layer 3L5, the conductive patch 301, the isolating slit 302, the top layer-conductor 306, three intermediate layer-conductors 306, a bottom layer-conductor 306, two coupling apertures 307, two conductive dispersion plates 308, two separation slits 309, a substrate material 310 and a section of a waveguide 311.

FIG. 6C is a vertical cross-sectional view of the wideband transit ion shown in FIG. 6A on 3C-3C section. FIG. 6C shows the top conductor-layer 3L1, the intermediate conductor-layers 3L2 to 3L4, the bottom conductor-layer 3L5, the conductive patch 301, the isolating slit 302, one of the plurality of ground vias 303 of the wideband transition, the segment of the planar transmission line 305, the top layer-conductor 306, three intermediate layer-conductor 306, the bottom layer-conductor 306, two coupling apertures 307, two conductive dispersion plates 308, two separation slit 309, the substrate material 310 and the section of the waveguide 311.

FIG. 6D is a horizontal cross-sectional view of the wideband transition shown in FIG. 6A on the sections at conductor-layers 3L2 and 3L4. FIG. 6D shows the plurality of ground vias 303 of the wideband transition, the plurality of ground vias 304 of the planar transmission line 305, one of the intermediate layer-conductors 306 and one of the coupling apertures 307.

FIG. 6E is a horizontal cross-sectional view of the wideband transition shown in FIG. 6A on the section at conductor-layer 3L3. FIG. 6E shows the plurality of ground vias 303 of the wideband transition, the plurality of ground vias 304 of the planar transmission line 305, one of the intermediate layer-conductors 306, one of the conductive dispersion plates 308 and one of the separation slits 309.

FIG. 6F is a horizontal cross-sectional view of the wideband transition shown in FIG. 6A on the section at conductor-layer 3L5. FIG. 6F shows the plurality of ground vias 303 of the wideband transition, the plurality of ground vias 304 of the planar transmission line 305, the bottom layer-conductor 306, the other one of the conductive dispersion plates 308, the other one of the separation slits 309 and the corrugation 312.

FIG. 6G is a bottom view of the wideband transition shown in FIG. 6A. FIG. 6G shows the bottom layer-conductor 306 and the section of the waveguide 311.

In FIGS. 6A to 6G, further another exemplary embodiment of a wideband transition between a planar transmission line 305 and a waveguide 311 is presented. In the present exemplary embodiment, the wideband transition is formed in a substrate comprising five conductor-layers 3L1, 3L2, 3L3, 3L4 and 3L5, which are isolated by a material 310.

Each element shown in FIGS. 6A to 6G corresponds to an element shown in FIGS. 1A to 1G in its functional capability. That is, the plurality of conductor-layers 3L1 to 3L5 corresponds to the plurality of conductor-layers 1L1 to 1L5. The top conductor-layer 3L1 corresponds to the top conductor-layer 1L1. The bottom conductor-layer 3L5 corresponds to the bottom conductor-layer 1L5. The intermediate conductor-layers 3L2 and 3L4 correspond to the intermediate conductor-layers 1L2 to 1L4. The conductive patch 301 corresponds to the conductive patch 101. The isolating slit 302 corresponds to the isolating slit 102. The plurality of ground vias 303 of the wideband transition corresponds to the plurality of ground vias 103 of the wideband transition. The plurality of ground vias 304 of the planar transmission line 305 corresponds to the plurality of ground vias 104 of the planar transmission line 105. The segment of the planar transmission line 305 corresponds to the segment of the planar transmission line 105. The top layer-conductor 306 corresponds to the top layer-conductor 106. The bottom layer-conductor 306 corresponds to the bottom layer-conductor 106. The intermediate layer-conductors 306 in intermediate conductor-layers 3L2 and 3L4 correspond to the intermediate layer-conductors 106. The conductive dispersion plate 308 in the bottom conductor-layer 3L5 corresponds to the conductive dispersion plate 108. The separation slit 309 in the bottom conductor-layer 3L5 corresponds to the separation slit 109 in the bottom conductor-layer 1L5. The substrate material 310 corresponds to the substrate material 110. The section of the waveguide 311 corresponds to the section of the waveguide 111. The corrugation 312 in the conductive dispersion plate 308 in the bottom conductor-layer 3L5 corresponds to the corrugation 112 in the conductive dispersion plate 108.

While the wideband transition shown in FIGS. 1A to 1G includes one conductive dispersion plate 108 with the corrugation 112 and one separation slit 109 in the bottom conductor-layer 1L5, the wideband transition in the present exemplary embodiment includes two conductive dispersion plates 308 and two separation slits 309 in the bottom conductor-layer 3L5 and the intermediate conductor-layer 3L3. In other words, the coupling aperture 107 in the intermediate conductor-layer 1L3 is replaced by a set of the conductive dispersion plate 308 and the separation slit 309 both in the intermediate conductor-layer 3L3.

In present embodiment, the wideband transition is formed by the conductor patch 301 connected to one end of the segment of the planar transmission line 305, the isolating slit 302 disposed between a set of the conductor patch 301 and the segment of the planar transmission line 305 and other conductors arranged in the top conductor-layer 3L1, the plurality of ground vias 303 of the wideband transition, the coupling apertures 307 disposed under the conductor patch 301 in the intermediate conductor-layers 3L2 and 3L4, the conductive dispersion plates 308 disposed in the conductor-layers 3L3 and 3L5 and the separation slits 309 isolating the conductive dispersion plates 308 from other conductors in the conductor-layers 3L3 and 3L5.

In this embodiment, another end of the segment of the planar transmission line 305 serves as a first terminal. Also, one end of the section of the waveguide 311 is disposed under the conductive dispersion plate 308 and another end of the section of the waveguide 311 acts as a second terminal of the wideband transition. To improve the electrical performance of the segment of the planar transmission line 305, the plurality of ground vias 304 is arranged along the segment of the planar transmission line 305.

In the wideband transition in the present exemplary embodiment, two different types of conductive dispersion plates 308 are used. A first conductive dispersion plate 308 disposed at the intermediate conductor-layer 3L3 has all smooth edges while a second conductive dispersion plate 308 disposed at the bottom conductor-layer 3L5 has an edge with specific corrugation 312.

### Further Another Exemplary Embodiment

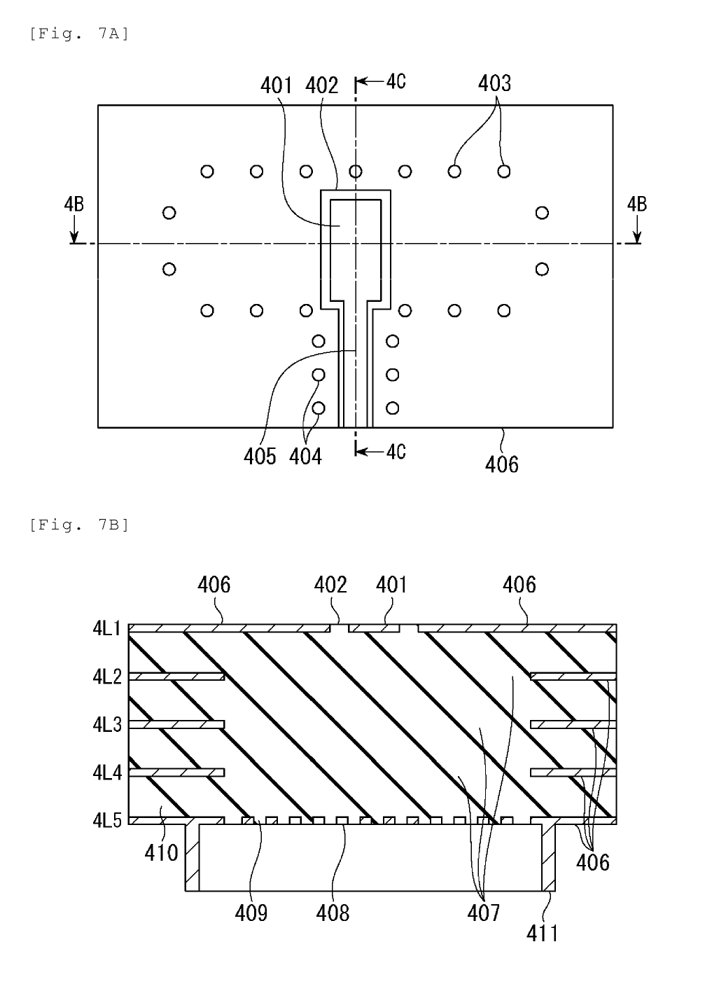

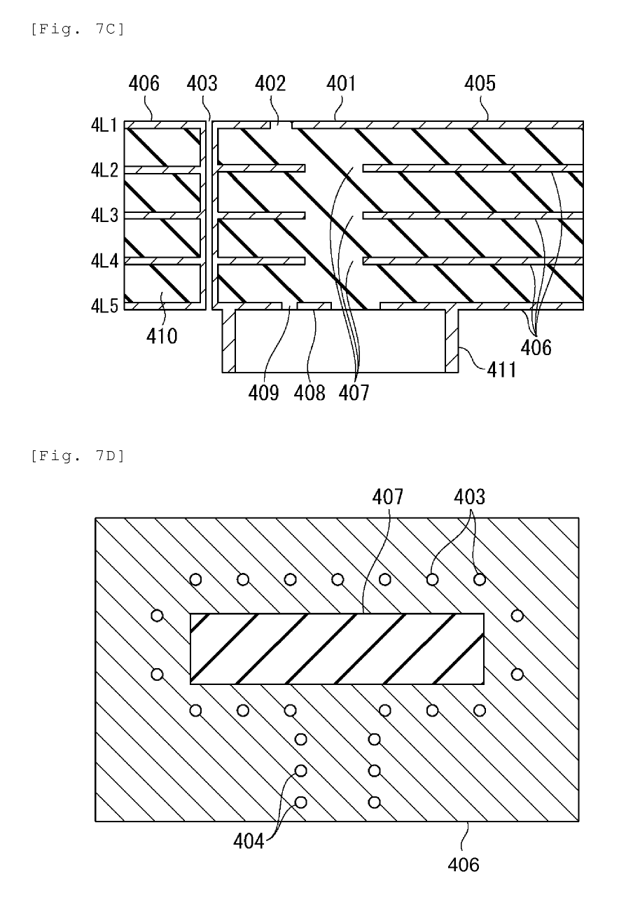

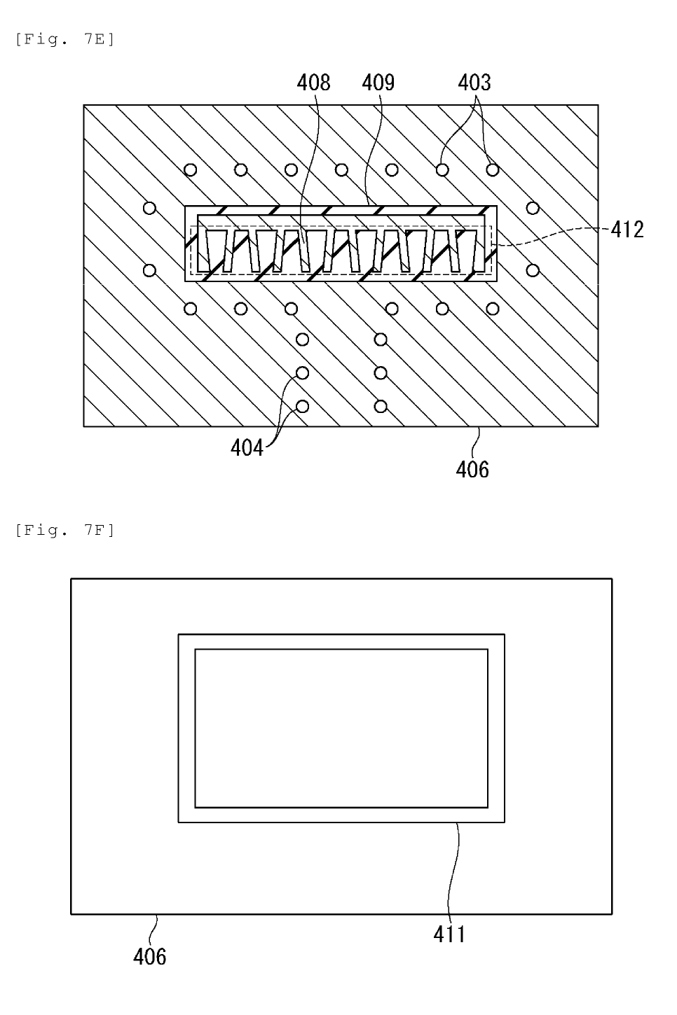

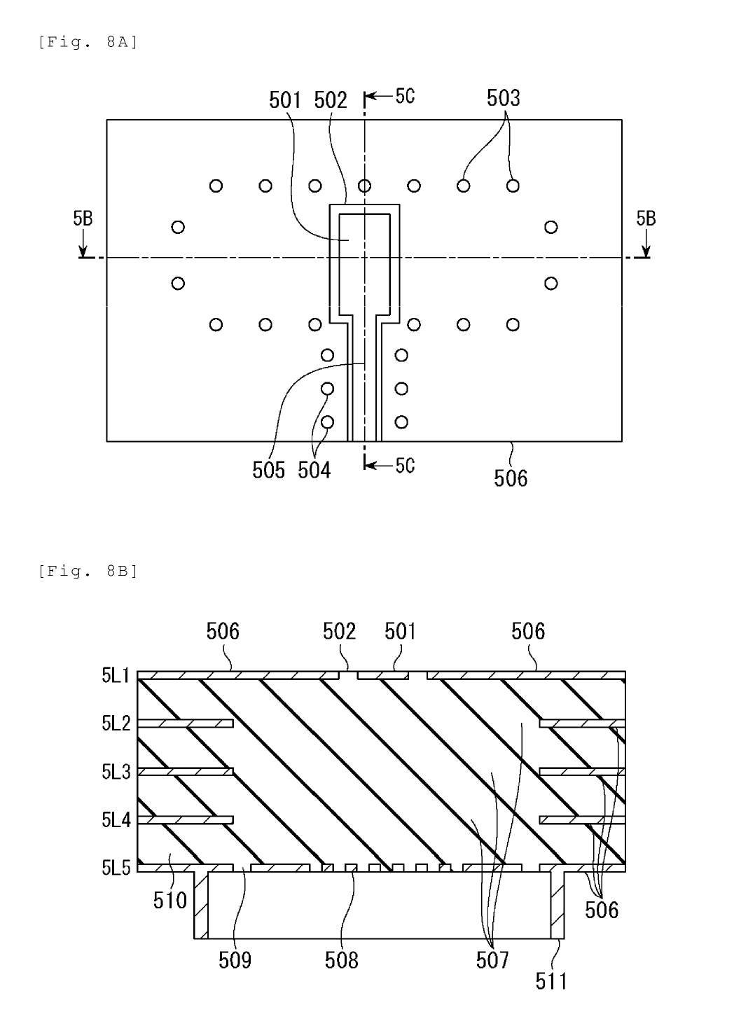

FIG. 7A is a top view of a wideband transition between a planar transmission line and a waveguide of a further another exemplary embodiment of the present invention. FIG. 7A shows a conductive patch 401, an isolating slit 402, a plurality of ground vias 403 of the wideband transition, a segment of a planar transmission line 405, a plurality of ground vias 404 of the planar transmission line 405 and two section lines 4B-4B and 4C-4C.

FIG. 7B is a vertical cross-sectional view of the wideband transit ion shown in FIG. 7A on 4B-4B section. FIG. 7B shows a top conductor-layer 4L1, three intermediate conductor-layers 4L2 to 4L4, a bottom conductor-layer 4L5, the conductive patch 401, the isolating slit 402, the top layer-conductor 406, three intermediate layer-conductor 406, a bottom layer-conductor 406, a plurality of coupling apertures 407, a conductive dispersion plate 408, a separation slit 409, a substrate material 410 and a section of a waveguide 411.

FIG. 7C is a vertical cross-sectional view of the wideband transit ion shown in FIG. 7A on 4C-4C section. FIG. 7C shows the top conductor-layer 4L1, the three intermediate conductor-layers 4L2 to 4L4, the bottom conductor-layer 4L5, the conductive patch 401, the isolating slit 402, one of the plurality of ground vias 403 of the wideband transition, the segment of the planar transmission line 405, the top layer-conductor 406, the three intermediate layer-conductor 406, the bottom layer-conductor 406, the plurality of coupling apertures 407, the conductive dispersion plate 408, the separation slit 409, the substrate material 410 and the section of the waveguide 411.

FIG. 7D is a horizontal cross-sectional view of the wideband transition shown in FIG. 7A on the sections at conductor-layers 4L2, 4L3, and 4L4. FIG. 7D shows one of the plurality of intermediate layer-conductors 406, one of the plurality of the coupling apertures 407, the plurality of ground vias 403 of the wideband transition and the plurality of ground vias 404 of the planar transmission line 405.

FIG. 7E is a horizontal cross-sectional view of the wideband transition shown in FIG. 7A on the section at conductor-layer 4L5. FIG. 7E shows one of the plurality of intermediate layer-conductors 406, the conductive dispersion plate 408 with a corrugation 412, the separation slit 409, the plurality of ground vias 403 of the wideband transition and the plurality of ground vias 404 of the planar transmission line 405.

FIG. 7F is a bottom view of the wideband transition shown in FIG. 7A. FIG. 7F shows the bottom layer-conductor 406 and the section of the waveguide 411.

In FIGS. 7A to 7F, further another exemplary embodiment of a wideband transition between the planar transmission line 405 and the waveguide 411 is presented. In the present exemplary embodiment, the wideband transition is formed in a substrate comprising five conductor-layers 4L1, 4L2, 4L3, 4L4 and 4L5, which are isolated by the substrate material 410.

Each element shown in FIGS. 7A to 7F corresponds to an element shown in FIGS. 1A to 1G in its functional capability. That is, the plurality of conductor-layers 4L1 to 4L5 corresponds to the plurality of conductor-layers 1L1 to 1L5. The top conductor-layer 4L1 corresponds to the top conductor-layer 1L1. The bottom conductor-layer 4L5 corresponds to the bottom conductor-layer 1L5. The intermediate conductor-layers 4L2 to 4L4 correspond to the intermediate conductor-layers 1L2 to 1L4. The conductive patch 401 corresponds to the conductive patch 101. The isolating slit 402 corresponds to the isolating slit 102. The plurality of ground vias 403 of the wideband transition corresponds to the plurality of ground vias 103 of the wideband transition. The plurality of ground vias 404 of the planar transmission line 405 corresponds to the plurality of ground vias 104 of the planar transmission line 105. The segment of the planar transmission line 405 corresponds to the segment of the planar transmission line 105. The top layer-conductor 406 corresponds to the top layer-conductor 106. The bottom layer-conductor 406 corresponds to the bottom layer-conductor 106. The intermediate layer-conductors 406 correspond to the intermediate layer-conductors 106. The separation slit 409 corresponds to the separation slit 109. The substrate material 410 corresponds to the substrate material 110. The section of the waveguide 411 corresponds to the section of the waveguide 111.

While the corrugation 112 of the conductive dispersion plate 108 has ridges and grooves with a rectangular shape, the corrugation 412 of the conductive dispersion plate 408 in the present exemplary embodiment of the wideband transition has ridges with a shape of trapeze or parallelogram and grooves with a trapezoidal shape. In other words, the conductive dispersion plate 108 having the corrugation 112 with rectangular ridges and rectangular grooves is replaced by the conductive dispersion plate 408 with the corrugation 412 having ridges with a shape of trapeze or parallelogram and grooves with a trapezoidal shape.

In present embodiment, the wideband transition is formed by the conductor patch 401 connected to one end of the segment of the planar transmission line segment 405, the isolating slit 402 disposed between the conductor patch 401 and other conductors arranged in the conductor-layer 4L1, the plurality of ground vias 403 of the wideband transition, the coupling apertures 407 disposed under the conductor patch 401 in the intermediate conductor-layers 4L2, 4L3 and 4L4, the conductive dispersion plate 408 disposed in the bottom conductor-layer 4L5 and the separation slits 409 isolating the conductive dispersion plates 408 from other conductors in the bottom conductor-layer 4L5.

In the present exemplary embodiment, another end of the segment of the planar transmission line 405 serves as a first terminal. Also, one end of the section of the waveguide 411 is disposed under the conductive dispersion plate 408 and another end of the section of the waveguide 411 acts as a second terminal of the wideband transition. To improve the electrical performance of the segment of the planar transmission line 405, the plurality of ground vias 404 are arranged along the segment of the planar transmission line 405.

In the wideband transition of the present exemplary embodiment, the specific corrugation 412 is used in the conductive dispersion plate 408. In this corrugation 412, a trapezoidal form of grooves is used to increase the effective length of the ridges.

### Further Another Exemplary Embodiment

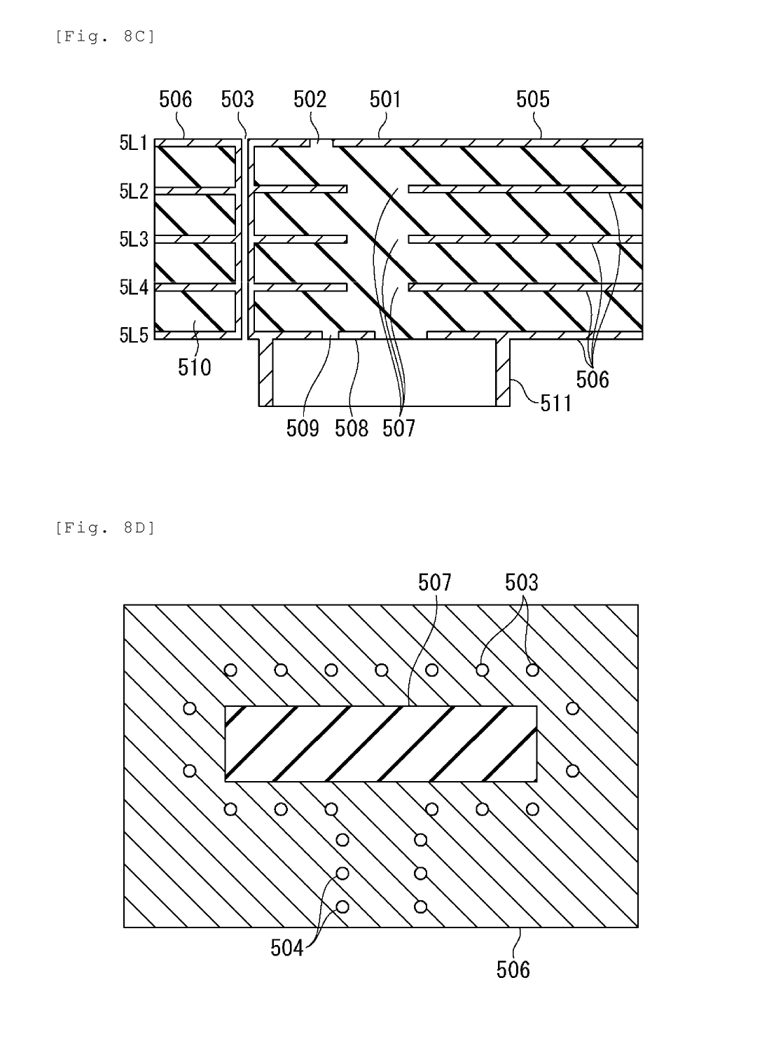

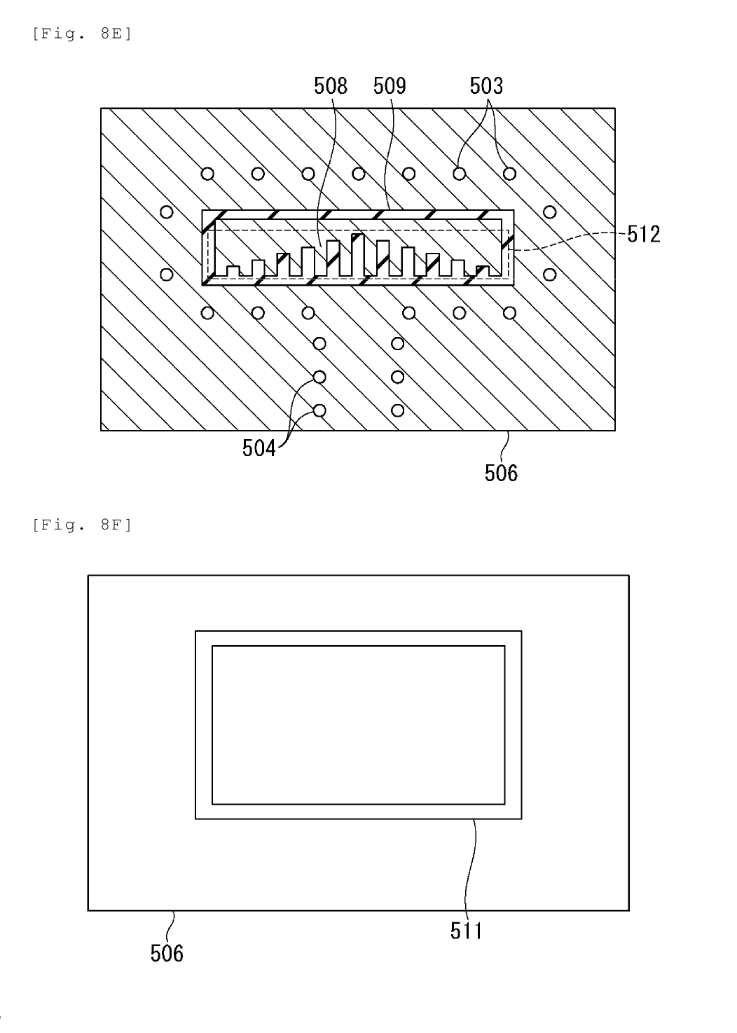

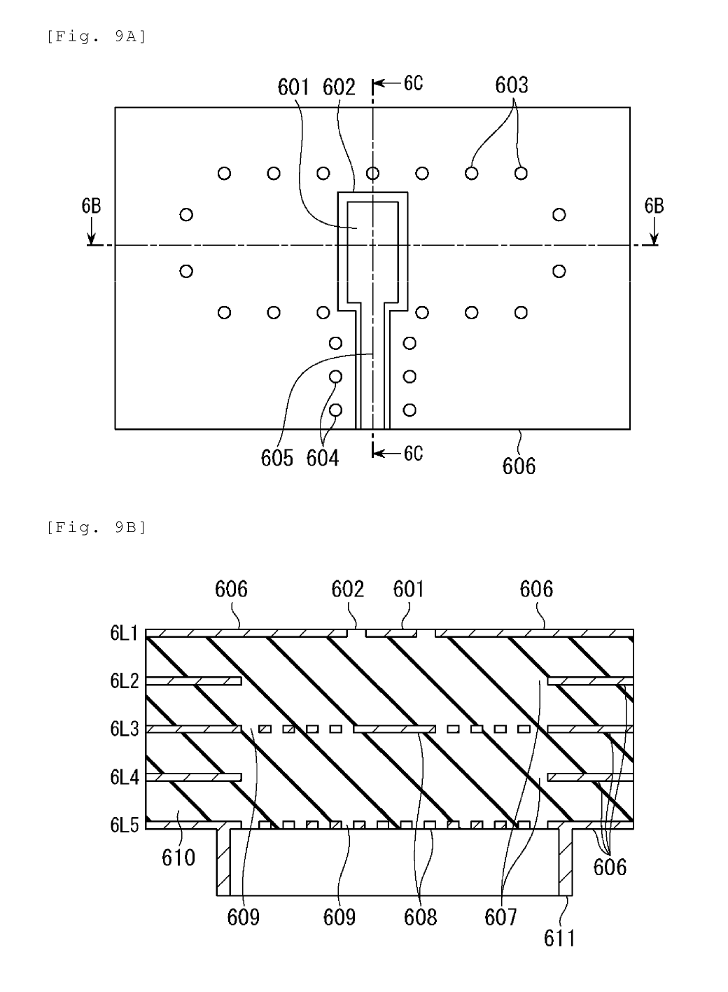

FIG. 8A is a top view of a wideband transition between a planar transmission line and a waveguide of a further another exemplary embodiment of the present invention. FIG. 8A shows a conductive patch 501, an isolating slit 502, a plurality of ground vias 503 of the wideband transition, a segment of a planar transmission line 505, a plurality of ground vias 504 of the planar transmission line 505 and two section lines 5B-5B and 5C-5C.

FIG. 8B is a vertical cross-sectional view of the wideband transition shown in FIG. 8A on 5B-5B section. FIG. 8B shows a top conductor-layer 5L1, three intermediate conductor-layers 5L2 to 5L4, a bottom conductor-layer 5L5, the conductive patch 501, the isolating slit 502, the top layer-conductor 506, three intermediate layer-conductors 506, a bottom layer-conductor 506, a plurality of coupling apertures 507, a conductive dispersion plate 508, a separation slit 509, a substrate material 510 and a section of a waveguide 511.

FIG. 8C is a vertical cross-sectional view of the wideband transition shown in FIG. 8A on 5C-5C section. FIG. 8C shows the top conductor-layer 5L1, the three intermediate conductor-layers 5L2 to 5L4, the bottom conductor-layer 5L5, the conductive patch 501, the isolating slit 502, one of the plurality of ground vias 503 of the wideband transition, the segment of the planar transmission line 505, the top layer-conductor 506, the three intermediate layer-conductors 506, the bottom layer-conductor 506, the plurality of coupling apertures 507, the conductive dispersion plate 508, the separation slit 509, the substrate material 510 and the section of the waveguide 511.

FIG. 8D is a horizontal cross-sectional view of the wideband transition shown in FIG. 8A on the sections at conductor-layers 5L2, 5L3, and 5L4. FIG. 8D shows one of the plurality of intermediate layer-conductors 506, one of the plurality of the coupling apertures 507, the plurality of ground vias 503 of the wideband transition and the plurality of ground vias 504 of the planar transmission line 505.

FIG. 8E is a horizontal cross-sectional view of the wideband transition shown in FIG. 8A on the section at conductor-layer 5L5. FIG. 8E shows one of the plurality of layer-conductors 506, the conductive dispersion plate 508 with a corrugation 512, the separation slit 509, the plurality of ground vias 503 of the wideband transition and the plurality of ground vias 504 of the planar transmission line 505.

FIG. 8F is a bottom view of the wideband transition shown in FIG. 8A. FIG. 8F shows the bottom layer-conductor 506 and the section of the waveguide 511.

In FIGS. 8A to 8F, further another exemplary embodiment of a wideband transition between the planar transmission line 505 and the waveguide 511 is presented. In the present exemplary embodiment, the wideband transition is formed in a substrate comprising five conductor-layers 5L1, 5L2, 5L3, 5L4 and 5L5, which are isolated by the substrate material 510.

Each element shown in FIGS. 8A to 8F corresponds to an element shown in FIGS. 1A to 1G in its functional capability. That is, the plurality of conductor-layers 5L1 to 5L5 corresponds to the plurality of conductor-layers 1L1 to 1L5. The top conductor-layer 5L1 corresponds to the top conductor-layer 1L1. The bottom conductor-layer 5L5 corresponds to the bottom conductor-layer 1L5. The intermediate conductor-layers 5L2 to 5L4 correspond to the intermediate conductor-layers 1L2 to 1L4. The conductive patch 501 corresponds to the conductive patch 101. The isolating slit 502 corresponds to the isolating slit 102. The plurality of ground vias 503 of the wideband transition corresponds to the plurality of ground vias 103 of the wideband transition. The plurality of ground vias 504 of the planar transmission line 505 corresponds to the plurality of ground vias 104 of the planar transmission line 105. The segment of the planar transmission line 505 corresponds to the segment of the planar transmission line 105. The top layer-conductor 506 corresponds to the top layer-conductor 106. The bottom layer-conductor 506 corresponds to the bottom layer-conductor 106. The intermediate layer-conductors 506 correspond to the intermediate layer-conductors 106. The separation slit 509 corresponds to the separation slit 109. The substrate material 510 corresponds to the substrate material 110. The section of the waveguide 511 corresponds to the section of the waveguide 111.

While the corrugation 112 of the conductive dispersion plate 108 has ridges with a same length and grooves with a same depth, the corrugation 512 of the conductive dispersion plate 508 in the present exemplary embodiment of the wideband transition has ridges with different lengths and grooves with different depths. In other words, the conductive dispersion plate 108 having the corrugation 112 with rectangular ridges and rectangular grooves is replaced by the conductive dispersion plate 508 with the corrugation 512 having ridges and grooves with different lengths. In the case shown in FIG. 8E, a length of ridges and a depth of grooves are greater in a central region and smaller in peripheral region, along the edge on which ridges and grooves are arranged.

In present embodiment, the wideband transition is formed by the conductor patch 501 connected to one end of the planar transmission line segment 505, the isolating slit 502 disposed between the conductor patch 501 and other conductors arranged in the top conductor-layer 5L1, the plurality of ground vias 503 of the wideband transition, the coupling apertures 507 disposed under the conductor patch 501 in the intermediate conductor-layers 5L2, 5L3 and 5L4, the conductive dispersion plates 508 in the bottom conductor-layer 5L5, and the separation slit 509 isolating the conductive dispersion plates 508 from other conductors in the bottom conductor-layer 5L5. In the present exemplary embodiment, another end of the segment of the planar transmission line 505 serves as a first terminal. Also, one end of the section of the waveguide 511 is disposed under the conductive dispersion plate 508 and another end of the section of the waveguide 511 acts as a second terminal of the wideband transition. To improve the electrical performance of the planar transmission line 505, the plurality of ground vias 504 are arranged along the segment of the planar transmission line 505.

In the wideband transition, the specific corrugation 512 is arranged in the conductive dispersion plate 508. In this corrugation 512, the ridges have different lengths and the grooves have different depths to control the wideband operation of the transition.

### Further Another Exemplary Embodiment

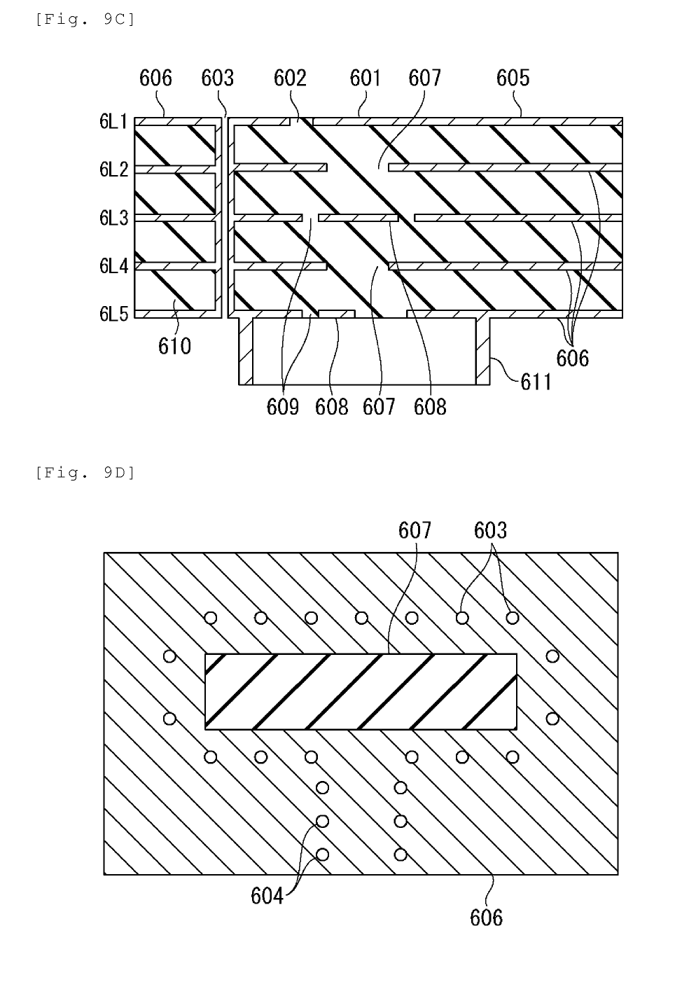

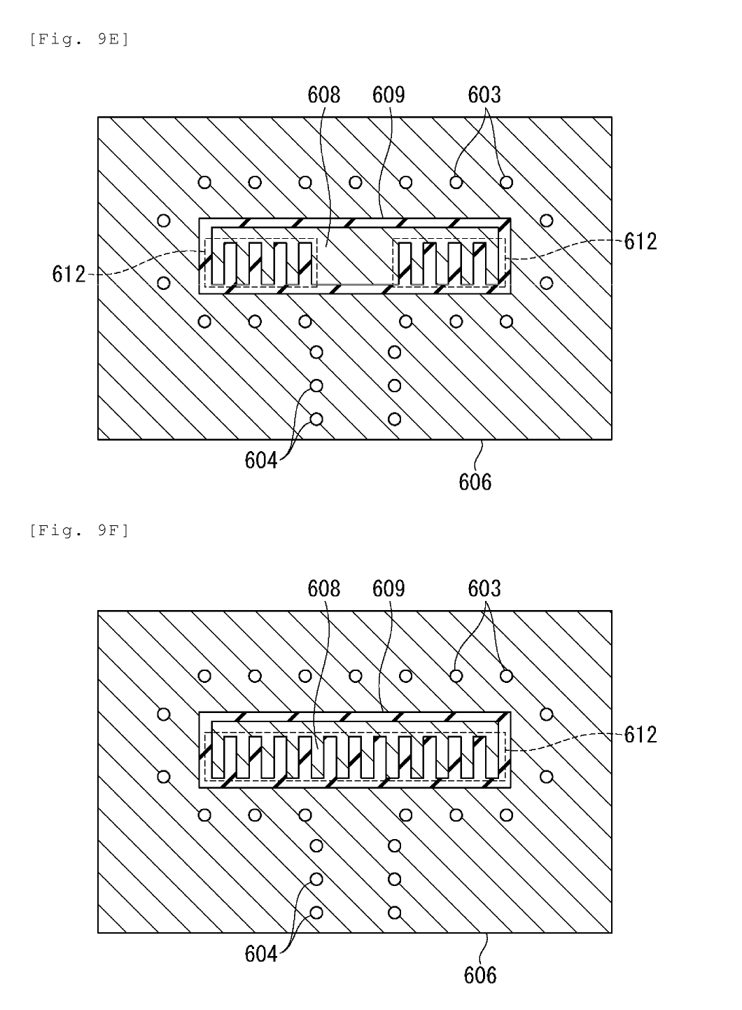

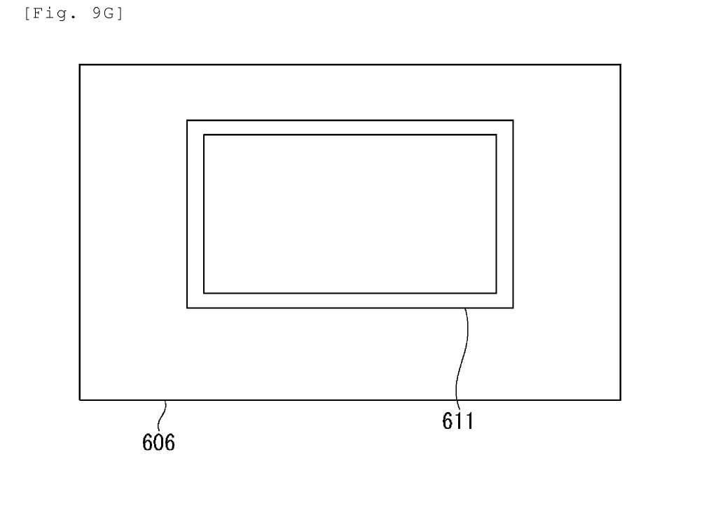

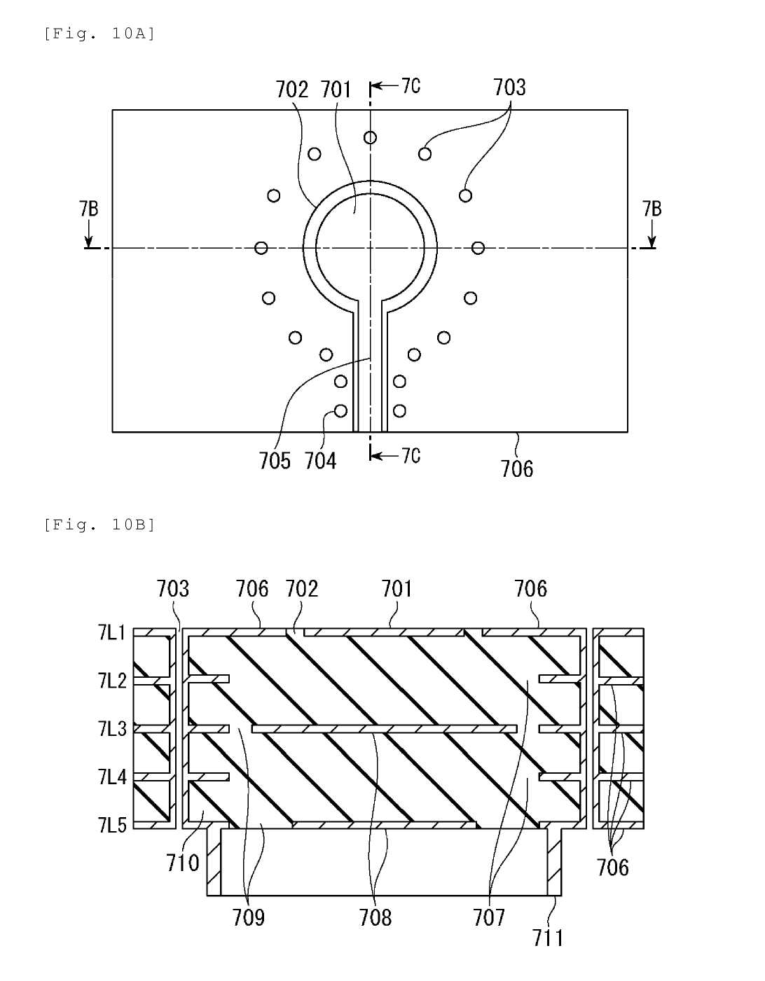

FIG. 9A is a top view of a wideband transition between a planar transmission line and a waveguide of a further another exemplary embodiment of the present invention. FIG. 9A shows a conductive patch 601, an isolating slit 602, a plurality of ground vias 603 of the wideband transition, a segment of a planar transmission line 605, a plurality of ground vias 604 of the planar transmission line 605, a top layer-conductor 606 and two section lines 6B-6B and 6C-6C.

FIG. 9B is a vertical cross-sectional view of the wideband transition shown in FIG. 9A on 6B-6B section. FIG. 9B shows a top conductor-layer 6L1, intermediate conductor-layers 6L2 to 6L4, a bottom conductor-layer 6L5, the conductive patch 601, the isolating slit 602, the top layer-conductor 606, three intermediate layer-conductors 606, a bottom layer-conductor 606, two coupling apertures 607, two conductive dispersion plates 608, two separation slit 609, a substrate material 610 and a section of a waveguide 611.

FIG. 9C is a vertical cross-sectional view of the wideband transition shown in FIG. 9A on 6C-6C section. FIG. 9C shows the top conductor-layer 6L1, the intermediate conductor-layers 6L2 to 6L4, the bottom conductor-layer 6L5, the conductive patch 601, the isolating slit 602, one of the plurality of ground vias 603 of the wideband transition, the segment of the planar transmission line 605, the top layer-conductor 606, three intermediate layer-conductors 606, the bottom layer-conductor 606, two coupling apertures 607, two conductive dispersion plates 608, two separation slits 609, the substrate material 610 and the section of the waveguide 611.

FIG. 9D is a horizontal cross-sectional view of the wideband transition shown in FIG. 9A on the sections at conductor-layers 6L2 and 6L4. FIG. 9D shows the plurality of ground vias 603 of the wideband transition, the plurality of ground vias 604 of the planar transmission line 605, one of the intermediate layer-conductors 606 and one of the coupling apertures 607.

FIG. 9E is a horizontal cross-sectional view of the wideband transition shown in FIG. 9A on the section at conductor-layer 6L3. FIG. 9E shows the plurality of ground vias 603 of the wideband transition, the plurality of ground vias 604 of the planar transmission line 605, the intermediate layer-conductor 606 in the intermediate conductor-layer 6L3, one of the conductive dispersion plates 608 and one of the separation slits 609.

FIG. 9F is a horizontal cross-sectional view of the wideband transition shown in FIG. 9A on the section at conductor-layer 6L5. FIG. 9F shows the plurality of ground vias 603 of the wideband transition, the plurality of ground vias 604 of the planar transmission line 605, the bottom layer-conductor 606, the other one of the conductive dispersion plates 608, the other one of the separation slits 609 and the corrugation 612.

FIG. 9G is a bottom view of the wideband transition shown in FIG. 9A. FIG. 9G shows the bottom layer-conductor 606 and the section of the waveguide 611.

In FIGS. 9A to 9G, further another exemplary embodiment of a wideband transition between the planar transmission line 605 and the waveguide 611 is presented. In the present exemplary embodiment, the wideband transition is formed in a substrate comprising five conductor-layers 6L1, 6L2, 6L3, 6L4 and 6L5, which are isolated by the substrate material 610.

Each element shown in FIGS. 9A to 9G corresponds to an element shown in FIGS. 1A to 1G in its functional capability. That is, the plurality of conductor-layers 6L1 to 6L5 corresponds to the plurality of conductor-layers 1L1 to 1L5. The top conductor-layer 6L1 corresponds to the top conductor-layer 1L1. The bottom conductor-layer 6L5 corresponds to the bottom conductor-layer 1L5. The intermediate conductor-layers 6L2 and 6L4 correspond to the intermediate conductor-layers 1L2 to 1L4. The conductive patch 601 corresponds to the conductive patch 101. The isolating slit 602 corresponds to the isolating slit 102. The plurality of ground vias 603 of the wideband transition corresponds to the plurality of ground vias 103 of the wideband transition. The plurality of ground vias 604 of the planar transmission line 605 corresponds to the plurality of ground vias 104 of the planar transmission line 105. The segment of the planar transmission line 605 corresponds to the segment of the planar transmission line 105. The top layer-conductor 606 corresponds to the top layer-conductor 106. The bottom layer-conductor 606 corresponds to the bottom layer-conductor 106. The intermediate layer-conductors 606 in intermediate conductor-layers 6L2 and 6L4 correspond to the intermediate layer-conductors 106. The conductive dispersion plate 608 in the bottom conductor-layer 6L5 corresponds to the conductive dispersion plate 108. The separation slit 609 in the bottom conductor-layer 6L5 corresponds to the separation slit 109 in the bottom conductor-layer 1L5. The substrate material 610 corresponds to the substrate material 110. The section of the waveguide 611 corresponds to the section of the waveguide 111. The corrugation 612 in the conductive dispersion plate 608 in the bottom conductor-layer 6L5 corresponds to the corrugation 112 in the conductive dispersion plate 108.

While the wideband transition shown in FIGS. 1A to 1G includes one conductive dispersion plate 108 with the corrugation 112 and one separation slit 109 in the bottom conductor-layer 1L5, the wideband transition in the present exemplary embodiment includes two conductive dispersion plates 608 and two separation slits 609 in the bottom conductor-layer 6L5 and the intermediate conductor-layer 6L3. In other words, the coupling aperture 107 in the intermediate conductor-layer 1L3 is replaced by a set of the conductive dispersion plate 608 and the separation slit 609 both in the intermediate conductor-layer 6L3.

In the present exemplary embodiment, the wideband transition is formed by a conductor patch 601 connected to one end of the segment of the planar transmission line 605, the isolating slit 602 disposed between the conductor patch 601 and other conductors arranged in the top conductor-layer 6L1, the plurality of ground vias 603 of the wideband transition, the coupling apertures 607 disposed under the conductor patch 601 in the intermediate conductor-layers 6L2 and 6L4, the conductive dispersion plates 608 disposed in conductor-layers 6L3 and 6L5, and the separation slits 609 isolating the conductive dispersion plates 608 from other conductors at the intermediate conductor-layer 6L3 and the bottom conductor-layer 6L5. In the present exemplary embodiment, another end of the segment of the planar transmission line 605 serves as a first terminal. Also, one end of the section of the waveguide 611 is disposed under the conductive dispersion plate 608 in the bottom conductor-layer 6L5 and another end of the section of the waveguide 611 acts as a second terminal of the wideband transition. To improve the electrical performance of the planar transmission line 605, the plurality of ground vias 604 of the planar transmission line 605 are arranged along the segment of the planar transmission line 605.

In the wideband transition in the present exemplary embodiment, two different types of corrugations 612 are used in two conductive dispersion plates 608, respectively. In a first conductive dispersion plate 608 disposed in the intermediate conductor-layer 6L3, the corrugation 612 is formed along one edge of the conductive dispersion plate 608, in both end sections, while in a second conductive dispersion plate 608 disposed in the bottom conductor-layer 6L5, an edge is corrugated completely. In other words, the coupling aperture 607 in the intermediate conductor-layer 6L3 is replaced by a set of the first conductive dispersion plate 608 and the first separation slit 609 in the intermediate conductor-layer 6L3.

The shape of the first conductive dispersion plate 608 can be described as similar to the shape of the second conductive dispersion plate 608 except that the central region has a wider ridge.

### Further Another Exemplary Embodiment

It should be noted that the form of a conductor patch, a coupling aperture, a dispersion plate, and a ground via arrangement around the conductor patch can be different and defined by an application.

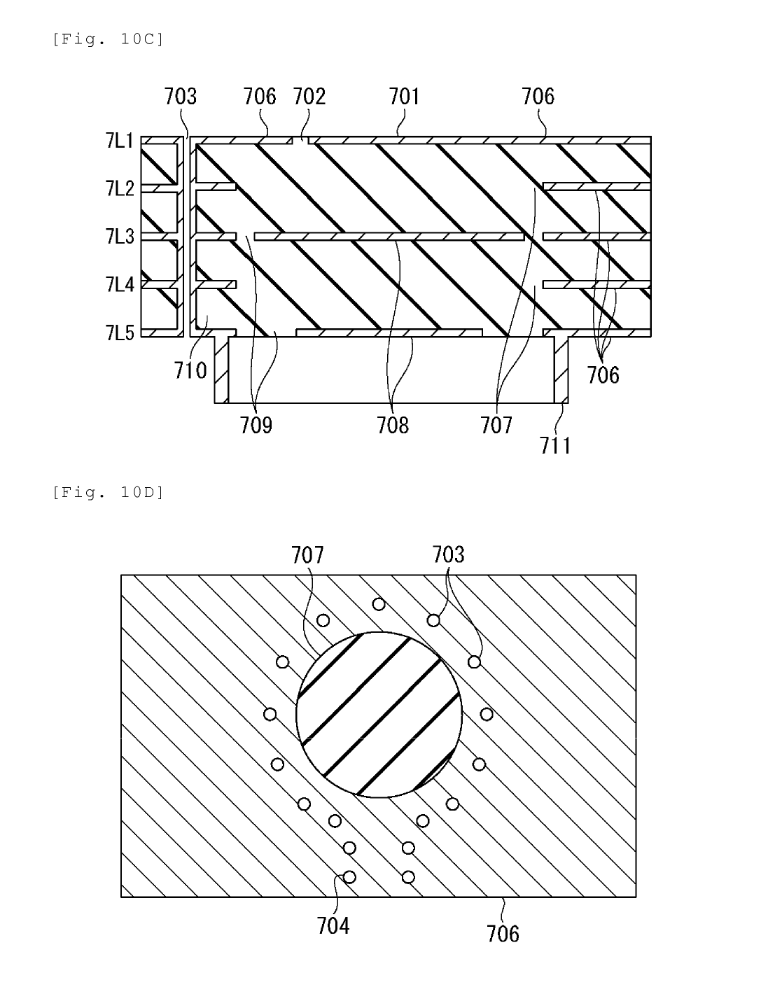

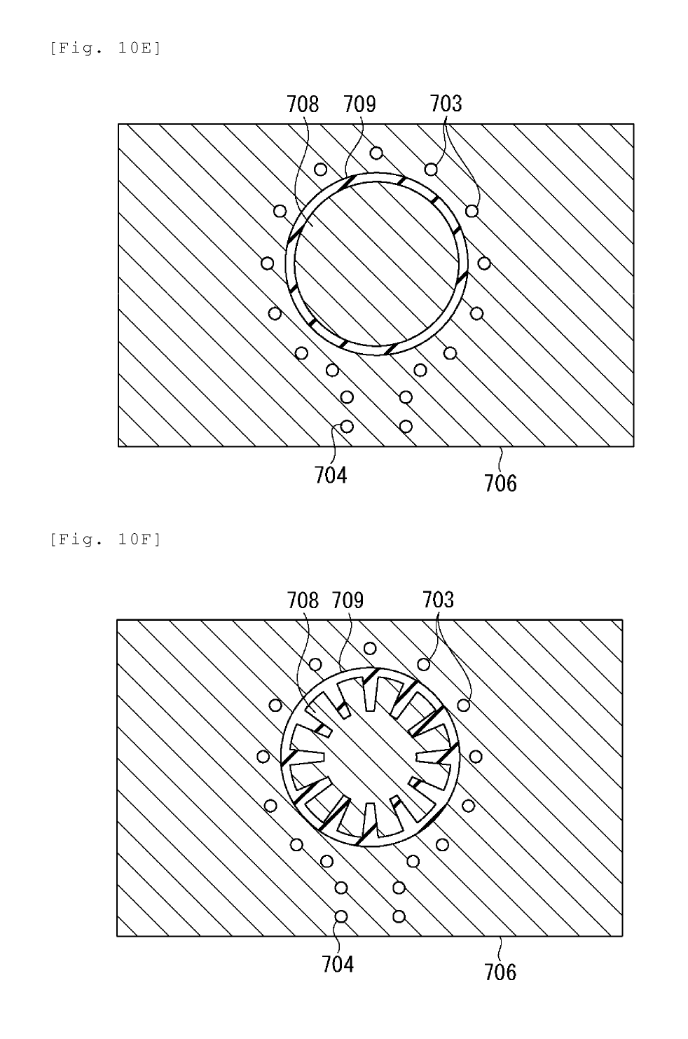

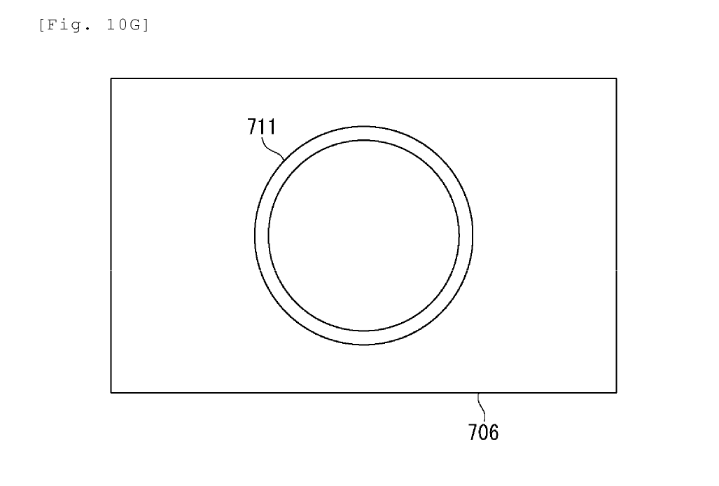

FIG. 10A is a top view of a wideband transition between a planar transmission line and a waveguide of a further another exemplary embodiment of the present invention. FIG. 10A shows a conductive patch 701, an isolating slit 702, a plurality of ground vias 703 of the wideband transition, a segment of a planar transmission line 705, a plurality of ground vias 704 of the planar transmission line 705, a top layer-conductor 706 and two section lines 7B-7B and 7C-7C.

FIG. 10B is a vertical cross-sectional view of the wideband transition shown in FIG. 10A on 7B-7B section. FIG. 10B shows a top conductor-layer 7L1, intermediate conductor-layers 7L2 to 7L4, a bottom conductor-layer 7L5, the conductive patch 701, the isolating slit 702, two of the plurality of ground vias 703 of the wideband transition, the top layer-conductor 706, three intermediate layer-conductors 706, a bottom layer-conductor 706, two coupling apertures 707, two conductive dispersion plates 708, two separation slits 709, a substrate material 710 and a section of a waveguide 711.

FIG. 10C is a vertical cross-sectional view of the wideband transition shown in FIG. 10A on 7C-7C section. FIG. 10C shows the top conductor-layer 7L1, the intermediate conductor-layers 7L2 to 7L4, the bottom conductor-layer 7L5, the conductive patch 701, the isolating slit 702, one of the plurality of ground vias 703 of the wideband transition, the segment of the planar transmission line 705, the top layer-conductor 706, three intermediate layer-conductors 706, the bottom layer-conductor 706, two coupling apertures 707, two conductive dispersion plates 708, two separation slits 709, the substrate material 710 and the section of the waveguide 711.

FIG. 10D is a horizontal cross-sectional view of the wideband transition shown in FIG. 10A on the sections at conductor-layers 7L2 and 7L4. FIG. 10D shows the plurality of ground vias 703 of the wideband transition, the plurality of ground vias 704 of the planar transmission line 705, one of the intermediate layer-conductors 706 and one of the coupling apertures 707.

FIG. 10E is a horizontal cross-sectional view of the wideband transition shown in FIG. 10A on the section at conductor-layer 7L3. FIG. 10E shows the plurality of ground vias 703 of the wideband transition, the plurality of ground vias 704 of the planar transmission line 705, one of the intermediate layer-conductors 706, one of the conductive dispersion plates 708 and one of the separation slits 709.

FIG. 10F is a horizontal cross-sectional view of the wideband transition shown in FIG. 10A on the section at conductor-layer 7L5. FIG. 10F shows the plurality of ground vias 703 of the wideband transition, the plurality of ground vias 704 of the planar transmission line 705, the bottom layer-conductor 706, the other one of the conductive dispersion plates 708, the other one of the separation slits 709 and the corrugation 712.

FIG. 10G is a bottom view of the wideband transition shown in FIG. 10A. FIG. 10G shows the bottom layer-conductor 706 and the section of the waveguide 711.

In FIGS. 10A to 10G, further another exemplary embodiment of a wideband transition between the planar transmission line 705 and the waveguide 711 is presented. In the present exemplary embodiment, the wideband transition is formed in a substrate comprising five conductor-layers 7L1, 7L2, 7L3, 7L4 and 7L5, which are isolated by the substrate material 710.

Each element shown in FIGS. 10A to 10G corresponds to an element shown in FIGS. 1A to 1G in its functional capability. That is, the plurality of conductor-layers 7L1 to 7L5 corresponds to the plurality of conductor-layers 1L1 to 1L5. The top conductor-layer 7L1 corresponds to the top conductor-layer 1L1. The bottom conductor-layer 7L5 corresponds to the bottom conductor-layer 1L5. The intermediate conductor-layers 7L2 and 7L4 correspond to the intermediate conductor-layers 1L2 to 1L4. The conductive patch 701 corresponds to the conductive patch 101. The isolating slit 702 corresponds to the isolating slit 102. The plurality of ground vias 703 of the wideband transition corresponds to the plurality of ground vias 103 of the wideband transition. The plurality of ground vias 704 of the planar transmission line 705 corresponds to the plurality of ground vias 104 of the planar transmission line 105. The segment of the planar transmission line 705 corresponds to the segment of the planar transmission line 105. The top layer-conductor 706 corresponds to the top layer-conductor 106. The bottom layer-conductor 706 corresponds to the bottom layer-conductor 106. The intermediate layer-conductors 706 in intermediate conductor-layers 7L2 and 7L4 correspond to the intermediate layer-conductors 106. The conductive dispersion plate 708 in the bottom conductor-layer 7L5 corresponds to the conductive dispersion plate 108. The separation slit 709 in the bottom conductor-layer 7L5 corresponds to the separation slit 109 in the bottom conductor-layer 1L5. The substrate material 710 corresponds to the substrate material 110. The section of the waveguide 711 corresponds to the section of the waveguide 111. The corrugation 712 in the conductive dispersion plate 708 in the bottom conductor-layer 7L5 corresponds to the corrugation 112 in the conductive dispersion plate 108.

While the wideband transition shown in FIGS. 1A to 1G includes the rectangular conductive patch 101, one rectangular conductive dispersion plate 108 with the corrugation 112, one rectangular separation slit 109 in the bottom conductor-layer 1L5 and three rectangular coupling apertures 107 in the intermediate conductor-layers 1L2 to 1L4, the wideband transition in the present exemplary embodiment includes the circular conductive patch 701, two circular conductive dispersion plates 708, two circular separation slits 709 in the bottom conductor-layer 7L5 and the intermediate conductor-layer 7L3 and two circular coupling apertures in the intermediate conductor-layers 7L2 and 7L4. Also, while the wideband transition shown in FIGS. 1A to 1G includes the section of the rectangular waveguide 111, the wideband transition in the present exemplary embodiment includes the section of the circular waveguide 711.

In other words, a set of the rectangular conductive patch 101, the segment of the planar transmission line 105 and the isolating slit 102 is replaced by a set of the circular conductive patch 701, the segment of the planar transmission line 705 and the isolating slit 702. The rectangular coupling aperture 107 in the intermediate conductor-layer 1L3 is replaced by a set of the circular conductive dispersion plate 708 without corrugation and the circular separation slit 709 both in the intermediate conductor-layer 7L3. A set of the rectangular conductive dispersion plate 108 and the rectangular separation slit 109 in the bottom conductor-layer 1L5 is replaced by a set of the circular conductive dispersion plate 708 with corrugation 712. The rectangular coupling apertures 107 in the intermediate conductor-layers 1L2 and 1L4 are replaced by the circular coupling apertures 717 in the intermediate conductor-layers 7L2 and 7L4. The section of the rectangular waveguide 111 is replaced by the section of the circular waveguide 711.

The corrugation 712 of the circular conductive dispersion plate 708 in the bottom conductor-layer 7L5 has ridges and grooves both arranged in radial directions. The ridges and grooves of the corrugation 712 have a trapezoidal shape with convex bases. In other words, the width of ridges and grooves of the corrugation 712 is broader or narrower in the peripheral region or central region of the circular dispersion plate 708, respectively. The ridges of the corrugation 712 have a same length and the grooves of the corrugation 712 have a same depth.

In the present exemplary embodiment, the wideband transition is formed by the conductor patch 701 connected to one end of the segment of the planar transmission line 705, the isolating slit 702 disposed between a set of the conductor patch 701 and the segment of the planar transmission line 705 and other conductors arranged in the top conductor-layer 7L1, the plurality of ground vias 703 of the wideband transition, two coupling apertures 707 disposed under the conductor patch 701 in the layers 7L2 and 7L4, two conductive dispersion plates 708 disposed in conductor-layers 7L3 and 7L5, and two separation slits 709 isolating the conductive dispersion plates 708 from other conductors in the intermediate conductor-layer 7L3 and the bottom conductor-layer 7L5. In the present exemplary embodiment, another end of the segment of the planar transmission line 705 serves as a first terminal. Also, one end of the section of the waveguide 711 is disposed under the conductive dispersion plate 708 and another end of the section of the waveguide 711 acts as a second terminal of the wideband transition. To improve the electrical performance of the planar transmission line 705, the plurality of ground vias 704 of the planar transmission line 705 are arranged along the segment of the planar transmission line 705.

In the wideband transition of the present exemplary embodiment, two different types of dispersion plates 708 are used. The conductive dispersion plate 708 disposed at the intermediate conductor-layer 7L3 is smooth, that is, has no corrugation on the edge, while the conductive dispersion plate 708 disposed in the bottom conductor-layer 7L5 has an edge with the specific corrugation 712. As one can see in FIGS. 10A, 10D, 10E and 10F, in the present exemplary embodiment, the round conductor patch 701, the round coupling apertures 707 and the round conductive dispersion plates 708 are used, in distinction to rectangular ones shown above-mentioned embodiments, to connect the second port of the wideband transition to a round waveguide.

While the present invention has been described in relation to some exemplary embodiments, it is to be understood that these exemplary embodiments are for the purpose of description by example, and not of limitation. While it will be obvious to those skilled in the art upon reading the present specification that various changes and substitutions may be easily made by equal components and art, it is obvious that such changes and substitutions lie within the true scope and spirit of the presented invention as defined by the claims.

1. A wideband transition between a planar transmission line and a waveguide, comprising:
a substrate including a plurality of conductor-layers stacked from top to bottom and isolated by an insulating material;
a segment of said planar transmission line disposed in a top conductor-layer of said plurality of conductor-layers; and
a section of said waveguide disposed on a bottom conductor-layer of said plurality of conductor-layers by a first end,
wherein said substrate comprises:
a conductive patch disposed in said top conductor-layer and connected to a first end of said segment;
a top ground plane disposed in said top conductor-layer by surrounding a set of said segment and said conductive patch;
an isolating slit disposed in said top conductor-layer and between said top ground plane and said set of said segment and said conductive patch;
a conductive dispersion plate disposed in said bottom conductor-layer and under said conductive patch;
a bottom ground plane disposed in said bottom conductor-layer by surrounding said conductive dispersion plate;
a separation slit disposed in said bottom conductor-layer and between said conductive dispersion plate and said bottom ground plane; and
a plurality of ground vias disposed through said substrate in a direction of said stacking from said top conductor-layer to said bottom conductor-layer and surrounding said conductive patch, said segment, said isolating slit, said conductive dispersion plate and said separation slit and connected to said top ground plane and said bottom ground plane,
wherein said conductive dispersion plate comprises a corrugation,
wherein said separation slit is disposed inward of an opening of said one end of said waveguide,
wherein a second end of said segment is a first terminal of said wideband transition, and
wherein a second end of said section is a second terminal of said wideband transition.

2. The wideband transition according to claim 1,
wherein said plurality of conductor-layer further comprises an intermediate conductor-layer disposed between said top conductor-layer and bottom conductor-layer, and
wherein said substrate further comprises:
another conductive dispersion plate disposed in said intermediate conductor-layer;
an intermediate ground plane disposed in said intermediate conductor-layer by surrounding said another conductive dispersion plate; and
another separating slit disposed in said intermediate conductor-layer and between said another conductive dispersion plate and said intermediate ground plane.

3. The wideband transition according to claim 1,
wherein said plurality of conductor-layers further comprises another intermediate conductor-layer disposed between said top conductor-layer and said bottom conductor-layer, and
wherein said substrate further comprises:
a coupling aperture with same peripheral dimensions as said separation slit and disposed in said another intermediate conductor-layer and over a set of said separation slit and said conductive dispersion plate; and
another intermediate ground plane disposed in said another intermediate conductor-layer by surrounding said coupling aperture and connected to said plurality of ground vias.

4. The wideband transition according to claim 1,
wherein said section has a rectangular shape,
wherein said conductive dispersion plate has a rectangular-envelop shape, and
wherein said corrugation comprises rectangular ridges with a same length.

5. The wideband transition according to claim 1,
wherein said section has a rectangular shape,
wherein said conductive dispersion plate has a rectangular-envelop shape, and
wherein said corrugation comprises trapezoidal ridges.

6. The wideband transition according to claim 1,
wherein said section has a rectangular shape,
wherein said conductive dispersion plate has a rectangular-envelop shape, and
wherein said corrugation comprises rectangular ridges with different lengths.

7. The wideband transition according to claim 1,
wherein said section has a circular shape, and
wherein said conductive dispersion plate has a circular-envelop shape.

8. The wideband transition according to claim 2,
wherein said section has a rectangular shape,
wherein said conductive dispersion plate has a rectangular-envelop shape,
wherein said corrugation comprises rectangular ridges, and
wherein said another conductive dispersion plate has a rectangular shape.

9. The wideband transition according to claim 2,
wherein said section has a rectangular shape,
wherein said conductive dispersion plate has a rectangular-envelop shape,
wherein said corrugation comprises rectangular ridges, and
wherein said another conductive dispersion plate has a rectangular shape and comprises corrugations with rectangular ridges.

10. The wideband transition according to claim 2,
wherein said section has a rectangular shape,
wherein said conductive dispersion plate has a rectangular-envelop shape,
wherein said corrugation comprises rectangular ridges with a same length, and
wherein said another conductive dispersion plate has a rectangular shape and comprises corrugations with rectangular ridges of a same length and different widths.
